(19) United States
(12) Patent Application Publication
(10) Pub. No.: US 2025/0247020 A1
(43) Pub. Date: Jul. 31, 2025

(54) ENERGY RECOVERY DRIVER FOR PZT ACTUATORS

(71) Applicants: STMicroelectronics International N.V., Geneva (CH); Politecnico Di Milano, Milano (IT)

(72) Inventors: Marco ZAMPROGNO, Cesano Maderno (MB) (IT); Raffaele Enrico FURCERI, Legnano (IT); Matteo GIANOLLO, Monza (MB) (IT); Giacomo LANGFELDER, Milano (IT)

(73) Assignees: STMicroelectronics International N.V., Geneva (CH); Politecnico Di Milano, Milano (IT)

(21) Appl. No.: 18/426,980

(22) Filed: Jan. 30, 2024

(51) Int. Cl. H02N 2/00

(52) U.S. Cl. CPC H02N 2/0075

(57) ABSTRACT

A piezoelectric actuator-system includes an inductor and driver-circuit having switches for transferring energy between first and second actuators and the inductor, and between a voltage-supply node and the inductor. Control circuitry determines whether a next phase in which to operate the driver-circuit is a charging-phase or a recovery-phase. Either the charging-phase or recovery-phase may include, after a freewheeling sub-phase, a pre-charge sub-phase to place a given one of the switches connected to the first actuator near a zero-voltage switching condition. Either the charging-phase or recovery-phase may include, after a sub-phase in which a parasitic capacitance is charged, an additional recovery sub-phase in which the charge from the parasitic capacitance is recovered to the voltage-supply node.

### TECHNICAL FIELD

This disclosure is related to the field of energy recovery drivers for piezoelectric actuators.

### BACKGROUND

Piezoelectric actuators are small devices, constructed for example from lead zirconate titanate, that produce a small displacement with a relatively high force capability when a voltage is applied. There are many applications where a piezoelectric actuator may be used, such as in speakers and linearly driven micromirrors. Such piezoelectric actuators are driven with low to medium frequency signals (e.g., up to 20 kHz) having a full-scale voltage range of up to 50V or more.

Piezoelectric actuators can be designed such that they are differentially driven and may be modeled as dual capacitive loads having capacitance values on the order of tens of nF. In order to achieve desired performance characteristics, piezoelectric actuator designs increasingly have higher capacitances, leading to stability/bandwidth issues when driven by conventional drivers.

Now described with reference to FIG. 1 is a conventional fully-differential linear driver 1 for a piezoelectric actuator that attempts to address the issues described above. The driver 1 includes a sigma-delta modulated digital to analog converter (DAC) 2 that receives data DAC_DATA as an input, is clocked by a clock DAC_CLK, and provides an analog version of the data DAC_DATA to a transimpedance amplifier (TIA) 3. The output of the TIA 3 is first amplified by a low-voltage driver (LVD) 4, and is then further amplified by a high-voltage driver (HVD) 5. The output of the HVD 5 is differential (two signals that change symmetrically about a common mode), continuous, and fed to the components of the piezoelectric actuator represented as the capacitors PZT1, PZT2 to thereby drive the piezoelectric actuator as desired. Notice that the HVD 5 is powered by a high voltage VHV (on the order of tens of volts) that is generated by a boost converter 6 external to the driver 1.

This design, however, suffers from several limitations. For example, power consumption is undesirably high. The use of multiple amplifiers 3, 4, and 5 that each consume a non-negligible amount of power, together with noise and linearity requirements, causes this high power consumption. In addition, since the HVD 5 is biased by the VHV voltage, and the quiescent current of the HVD 5 is non-negligible, further contributing to the high power consumption-worse, the higher the voltage VHV for a given quiescent current, the higher the contribution to the power consumption by the HVD 5. Still further, since no energy recovery is performed, the capacitors PZT1, PZT2 contribute to power consumption, as the charge on the capacitors is lost when they are discharged to ground during operation. Moreover, since the power consumption by the capacitors PZT1, PZT2 can be described as a C·V²·f term (with C being the capacitance of PZT1, PZT2, V being the voltage of the driving signal applied thereto, f being the frequency of the driving signal applied thereto) and since each value of this term has been increasing with recent designs, conventional designs which discharge the capacitances to ground are increasingly undesirable.

On top of power consumption concerns, conventional driver designs suffer from additional drawbacks. For example, the value of the capacitances PZT1, PZT2 are increasing in current designs as stated, having the effect of increasing the difficulty of stabilizing the HVD 5 and increasing the current consumption of the HVD 5.

Still further, noise and THD (total harmonic distortion) performance is of concern. The resolution of the output differential signal used to drive the piezoelectric actuator represented by the capacitances PZT1, PZT2 is to be relatively high, for example 16-bit, and therefore the noise and linearity of the output differential signal is to be compatible with this resolution, leading to increased power consumption by the amplifiers 3, 4, and 5 when they are so-designed, leading also to increased area. Since the signal to be managed by the amplifiers 3, 4, and 5 is of low to medium frequency, the low frequency noise is to be carefully managed. To carefully manage this term with conventional designs, complex designs for the amplifiers 3, 4, and 5 are utilized.

In addition, there are technological issues with conventional designs. The designs of the amplifiers 3, 4, and 5 may utilize components such as high resistance resistors and high voltage capacitors. High resistance resistors (on the order of megaohms) that might be used suffer from excess area consumption, lack of linearity, contribute to power consumption, and may include undesirable parasitics. High voltage capacitors often have poor yield, increasing production costs.

In view of this panoply of drawbacks with conventional driver designs, further development is needed.

### SUMMARY

Disclosed herein is a driver system for a differential piezoelectric actuator system. The driver system includes an inductor, and a driver circuit with switches for selectively facilitating transfer of energy between first and second actuators of the differential piezoelectric actuator system and the inductor and between a voltage supply node and the inductor. Control circuitry is present and configured to determine whether a next phase in which to operate the driver circuit is a first charging phase or a first recovery phase, based upon feedback signals.

In a first sub-phase of the first charging phase, the control circuitry operates the switches to transfer energy from the first actuator to the inductor, in a second sub-phase of the first charging phase, the control circuitry operates the switches to transfer energy from the voltage supply node to the inductor, and in a third sub-phase of the first charging phase, the control circuitry operates the switches to transfer energy from the inductor to the second actuator.

In a first sub-phase of the first recovery phase, the control circuitry operates the switches to transfer energy from the first actuator to the inductor, in a second sub-phase of the first recovery phase, the control circuitry operates the switches to transfer energy from the inductor to the voltage supply node, and in a third sub-phase of the first recovery phase, the control circuitry operates the switches to transfer energy from the inductor to the second actuator.

The control circuitry may be further configured to, in a fourth sub-phase of the first charging phase, operate the switches to maintain an inductor current through the inductor as being fixed, ready for a next phase in which the inductor current may be reversed.

The control circuitry may be further configured to, in a fourth sub-phase of the first recovery phase, operate the switches to maintain an inductor current through the inductor as being fixed, ready for a next phase in which the inductor current may be reversed.

The duration of the first sub-phase of the first charging phase may be set by the control circuitry based upon the feedback signals from the previous phase, a reference differential voltage, and a reference common mode voltage. A duration of the second sub-phase of the first charging phase may be set by the control circuitry based upon the feedback signals from the previous phase, the reference differential voltage, and the reference common mode voltage. A duration of the third sub-phase of the first charging phase may be set by the control circuitry based upon a zero crossing of an instantaneous value of an inductor current through the inductor. The feedback signals may be a differential between the voltages across the first and second actuators, a common mode of the voltages across the first and second actuators, and a continuous time value of the inductor current.

A duration of the first sub-phase of the first recovery phase may be set by the control circuitry based upon the feedback signals from the previous phase, a reference differential voltage, and a reference common mode voltage. A duration of the second sub-phase of the first recovery phase may be set by the control circuitry based upon the feedback signals from the previous phase, the reference differential voltage, and the reference common mode voltage. A duration of the third sub-phase of the first recovery phase may be set by the control circuitry based upon a zero crossing of the instantaneous value of the inductor current. The feedback signals may be a differential between the voltages across the first and second actuators, a common mode of the voltages across the first and second actuators, and a continuous time value of the inductor current.

The driver circuit may also include additional switches for selectively operating the driver circuit, under control of the control circuitry, as a boost converter to generate a high voltage for driving some of the switches, the high voltage being greater than a voltage at the voltage supply node.

The control circuitry may be further configured to whether the next phase in which to operate the driver circuit is a second charging phase or a second recovery phase, based upon the feedback signals.

The control circuitry may be further configured to, in a first sub-phase of the second charging phase, operate the switches to transfer energy from the second actuator to the inductor, in a second sub-phase of the second charging phase, operate the switches to transfer energy from the voltage supply node to the inductor, and in a third sub-phase of the second charging phase, operate the switches to transfer energy from the inductor to the first actuator.

The control circuitry may be further configured to, in a first sub-phase of the second recovery phase, operate the switches to transfer energy from the second actuator to the inductor, in a second sub-phase of the second recovery phase, operate the switches to transfer energy from the inductor to the voltage supply node, and in a third sub-phase of the second recovery phase, operate the switches to transfer energy from the inductor to the first actuator. The feedback signals may be a differential between the voltages across the first and second actuators, a common mode of the voltages across the first and second actuators, and a continuous time value of the inductor current.

The control circuitry may determine whether the next phase in which to operate the driver circuit is the first charging phase, the first recovery phase, the second charging phase, or the second recovery phase based upon the feedback signals by: a) determining an error value to be a difference between the differential between the voltages across the first and second actuators and a reference differential voltage; b) determining a reference sign to be a sign of a current value of a reference differential voltage; c) determining a reference slope sign to be a sign of a current slope of the reference differential voltage; d) determining a residual energy within the inductor; e) if a current phase in which the control circuitry is operating the driver circuit is the second recovery phase and error value and reference sign are both negative, determining the next phase to be the second charging phase; f) if the current phase in which the control circuitry is operating the driver circuit is the second recovery phase and error value and reference slope sign are both positive, determining the next phase to be the first charging phase; g) if the current phase in which the control circuitry is operating the driver circuit is the second charging phase and error value and reference slope sign are both positive, determining the next phase to be the first recovery phase; h) if the current phase in which the control circuitry is operating the driver circuit is the first recovery phase and error value and reference slope sign are both negative, determining the next phase to be the second charging phase; i) if the current phase in which the control circuitry is operating the driver circuit is the first recovery phase and error value and reference sign are both positive, determining the next phase to be the first charging phase; j) if the current phase in which the control circuitry is operating the driver circuit is the first charging phase and error value and reference slope sign are both negative, determining the next phase to be the second recovery phase; and if the next phase is not determined by e), f), g), h), i), and j), determining the next phase to be a repeat of the current phase.

A duration of the third sub-phase, either in the first recovery phase or the second recovery phase, may be indicative of the residual energy present after the second sub-phase. If the duration of the third sub-phase of the first recovery phase approaches zero, the next phase may be to be a first charging phase, and if the duration of the third sub-phase of the second recovery phase approaches zero, the next phase may be a second charging phase.

A duration of each next phase may or may not be predetermined and fixed.

Also disclosed herein is a driver system for a differential piezoelectric actuator system. The driver system includes an inductor and a driver circuit. The driver circuit includes a first switch connected between a first actuator of the differential piezoelectric actuator system and a first inductor node connected to a first terminal of the inductor, a second switch connected between the first inductor node and ground, a third switch connected between the first inductor node and a voltage supply node, the third switch including a first body diode configurable to have its anode connected to the first inductor node and its cathode connected to the voltage supply node, a fourth switch connected between a second inductor node and ground, the second inductor node connected to a second terminal of the inductor, a fifth switch connected between the voltage supply node and the second inductor node, the fifth switch including a second body diode configurable to have its anode connected to the second inductor node and its cathode connected to the voltage supply node, and a sixth switch connected between the second inductor node and a second actuator of the differential piezoelectric actuator system. The driver system includes control circuitry configured to determine whether a next phase in which to operate the driver circuit is a first charging phase, a first recovery phase, a second charging phase, or a second recovery phase based upon feedback signals.

In a first sub-phase of the first charging phase, the control circuitry causes the first and fourth switches to close to transfer energy from the first actuator to the inductor. In a second sub-phase of the first charging phase, the control circuitry causes the third and fourth switches to close to transfer energy from the voltage supply node to the inductor. In a third sub-phase of the first charging phase, the control circuitry causes the second and sixth switches to close to transfer energy from the inductor to the second actuator. In a first sub-phase of the second charging phase, the control circuitry causes the second and sixth switches to close to transfer energy from the second actuator to the inductor. In a second sub-phase of the second charging phase, the control circuitry causes the second and fifth switches to close to transfer energy from the voltage supply node to the inductor. In a third sub-phase of the second charging phase, the control circuitry causes the first and fourth switches to close to transfer energy from the inductor to the first actuator.

In a first sub-phase of the first recovery phase, the control circuitry causes the first and fourth switches to close to transfer energy from the first actuator to the inductor. In a second sub-phase of the first recovery phase, the control circuitry causes the second and fifth switches to close to transfer energy from the inductor to the voltage supply node. In a third sub-phase of the first recovery phase, the control circuitry causes the second and sixth switches to close to transfer energy from the inductor to the second actuator. In a first sub-phase of the second recovery phase, the control circuitry causes the second and sixth switches to close to transfer energy from the second actuator to the inductor. In a second sub-phase of the second recovery phase, the control circuitry causes the third and fourth switches to close to transfer energy from the inductor to the voltage supply node. In a third sub-phase of the second recovery phase, the control circuitry causes the first and fourth switches to close to transfer energy from the inductor to the first actuator.

The control circuitry may be further configured to, in a fourth sub-phase of the charging phase, close the second and fourth switches to keep an inductor current through the inductor fixed, ideally at zero, ready for the next period in which the current may be reversed or not.

The control circuitry may be further configured to, in a fourth sub-phase of the recovery phase, close the second and fourth switches to maintain an inductor current through the inductor as being fixed, ideally at zero, ready for the next period in which the current may be reversed or not.

A duration of the first sub-phase of the first charging phase may be set by the control circuitry based upon the feedback signals from the previous phase, a reference differential voltage, and a reference common mode voltage. A duration of the second sub-phase of the first charging phase may be set by the control circuitry based upon the feedback signals from the previous phase, the reference differential voltage, and the reference common mode voltage. A duration of the third sub-phase of the first charging phase may be set by the control circuitry based upon a zero crossing of an instantaneous value of an inductor current through the inductor.

The feedback signals comprise a differential between the voltages across the first and second actuators, and a common mode of the voltages across the first and second actuators, and a continuous time value of the inductor current.

A duration of the first sub-phase of the first recovery phase may be set by the control circuitry based upon the feedback signals from the previous phase, a reference differential voltage, and a reference common mode voltage. A duration of the second sub-phase of the first recovery phase may be set by the control circuitry based upon the feedback signals from the previous phase, the reference differential voltage, and the reference common mode voltage. A duration of the third sub-phase of the first recovery phase may be set by the control circuitry based upon a zero crossing of an instantaneous value of an inductor current through the inductor.

The feedback signals may be a differential between the voltages across the first and second actuators, a common mode of the voltages across the first and second actuators, and a continuous time value of the inductor current.

The feedback signals may be an average inductor current through the inductor and a differential between the voltages across the first and second actuators, and a common mode of the voltage across the first and second actuators. The control circuitry may determine whether the next phase in which to operate the driver circuit is a charging phase or a recovery phase based upon residual energy present after a third sub-phase of a current phase in which the driver circuit is being operated. The control circuitry may determine whether the next phase in which to operate the driver circuit is the first charging phase, the first recovery phase, the second charging phase, or the second recovery phase based upon the feedback signals by: a) determining an error value to be a difference between the differential between the voltages across the first and second actuators and a reference differential voltage; b) determining a reference sign to be a sign of a current value of a reference differential voltage; c) determining a reference slope sign to be a sign of a current slope of the reference differential voltage; d) determining a residual energy within the inductor; e) if a current phase in which the control circuitry is operating the driver circuit is the second recovery phase and error value and reference sign are both negative, determining the next phase to be the second charging phase; f) if the current phase in which the control circuitry is operating the driver circuit is the second recovery phase and error value and reference slope sign are both positive, determining the next phase to be the first charging phase; g) if the current phase in which the control circuitry is operating the driver circuit is the second charging phase and error value and reference slope sign are both positive, determining the next phase to be the first recovery phase; h) if the current phase in which the control circuitry is operating the driver circuit is the first recovery phase and error value and reference slope sign are both negative, determining the next phase to be the second charging phase; i) if the current phase in which the control circuitry is operating the driver circuit is the first recovery phase and error value and reference sign are both positive, determining the next phase to be the first charging phase; j) if the current phase in which the control circuitry is operating the driver circuit is the first charging phase and error value and reference slope sign are both negative, determining the next phase to be the second recovery phase; and if the next phase is not determined by e), f), g), h), i), and j), determining the next phase to be a repeat of the current phase.

A duration of the third sub-phase, either in the first recovery phase or the second recovery phase, may be indicative of the residual energy present after the second sub-phase. If the duration of the third sub-phase of the first recovery phase approaches zero, the next phase may be a first charging phase, and if the duration of the third sub-phase of the second recovery phase approaches zero, the next phase may be a second charging phase.

The driver circuit further comprises a seventh switch connected between the first inductor node and a high voltage node and an eighth switch connected between the second inductor node and the high voltage node; and wherein the control circuitry is configured to, after each third sub-phase, operate the driver circuit in boost mode to increase a voltage at the high voltage node to be greater than a voltage at the voltage supply node, so that the boost mode is performed during a same switching period as the first sub-phase, second sub-phase, and third sub-phase.

The control circuitry may operate the driver circuit in the boost mode by in a first boost sub-phase, close the second and fifth switches to cause transfer of energy from the voltage supply node into the inductor, and in a second boost sub-phase, close the fourth and seventh switches to thereby boost the voltage at the high voltage node.

The control circuitry may operate the driver in the boost mode by in a first boost sub-phase, close appropriate ones of the switches to cause transfer of energy from the voltage supply node into the inductor, and in a second boost sub-phase, close other appropriate ones of the switches to thereby boost the voltage at the high voltage node.

Disclosed herein is a driver system for a differential piezoelectric actuator system. The driver system includes: an inductor connected between first and second nodes; and a driver circuit comprising switches for selectively facilitating transfer of energy between first and second actuators of the differential piezoelectric actuator system and the inductor, and between a voltage supply node and the inductor.

The driver system further includes control circuitry configured to: determine whether a next phase in which to operate the driver circuit is a first charging phase or a first recovery phase, based upon feedback signals.

In the first charging phase, the control circuitry is configured to: in a first sub-phase, operate the switches to transfer energy from the first actuator to the inductor; in a second sub-phase, operate the switches to transfer energy from the voltage supply node to the inductor; in a third sub-phase, operate the switches to transfer energy from the inductor to the second actuator; and in a fourth sub-phase, operate the switches to cause the inductor to freewheel.

In the first recovery phase, the control circuitry is configured to: in a first sub-phase, operate the switches to transfer energy from the first actuator to the inductor; in a second sub-phase, operate the switches to transfer energy from the inductor to the voltage supply node; and in a third sub-phase, operate the switches to transfer energy from the inductor to the second actuator; in a fourth sub-phase, operate the switches to cause the inductor to freewheel.

Immediately after the third sub-phase of the first charging phase and/or immediately after the third sub-phase of the first recovery phase, the control circuitry is further configured to operate the switches to perform an additional recovery sub-phase to transfer energy stored in a parasitic capacitance associated with the second node to the voltage supply node.

The control circuitry may be configured to, during the additional recovery sub-phase, set a given one of the switches connected between the first node and the voltage supply node to conduct through a body diode of a transistor forming that given one of the switches.

The switches in the driver circuit may include: a first switch circuit connected between the first actuator and the first node; a second switch circuit connected between the first node and ground; a third switch circuit connected between the voltage supply node and the first node; a fourth switch circuit connected between the second node and ground; a fifth switch circuit connected between the voltage supply node and the second node; and a sixth switch circuit connected between the second node and the second actuator.

The third switch circuit may include: a third n-channel transistor having a source connected to the voltage supply node, a drain connected to the first node, and a gate coupled to receive a third gate drive signal from the control circuitry; a second transistor configured to connect a body of the third n-channel transistor to the drain of the third n-channel transistor during the additional recovery sub-phase; a third transistor configured to connect the body of the third n-channel transistor to the voltage supply node when the third n-channel transistor is set by the third gate drive signal to be on; and a fourth transistor configured to connect the body of the third n-channel transistor to ground when the third n-channel transistor is set by the third gate drive signal to be off.

The fifth switch circuit may include: a fifth n-channel transistor having a source connected to the voltage supply node, a drain connected to the second node, and a gate coupled to receive a fifth gate drive signal from the control circuitry; a sixth transistor configured to connect a body of the fifth n-channel transistor to the drain of the fifth n-channel transistor during the additional recovery sub-phase; a seventh transistor configured to connect the body of the fifth n-channel transistor to the voltage supply node when the fifth n-channel transistor is set by the fifth gate drive signal to be on; and an eighth transistor configured to connect the body of the fifth n-channel transistor to ground when the fifth n-channel transistor is set by the fifth gate drive signal to be off.

The control circuitry may be further configured to, immediately prior to the first sub-phase of the first charging phase and/or immediately prior to the first sub-phase of the first recovery phase, operate the switches to perform a pre-charge sub-phase to perform a pre-charge sub-phase to place a given one of the switches connected to the first actuator near a zero-voltage switching condition.

The first switch circuit may include: a first n-channel transistor having a drain connected to the first actuator, a source connected to the first node, and a gate coupled to receive a first gate drive signal from the control circuitry; a ninth transistor configured to selectively connect the gate of the first n-channel transistor to the source of the first n-channel transistor in order to configure the first n-channel transistor as a trans-diode during the pre-charge sub-phase; a tenth transistor configured to connect a body of the first n-channel transistor to ground when the first n-channel transistor is set by the first gate drive signal to be off; and an eleventh transistor configured to connect the body of the first n-channel transistor to the source of the first n-channel transistor when the first n-channel transistor is set by the first gate drive signal to be on, during the pre-charge sub-phase, and to exploit a body-drain junction of the first n-channel transistor.

The sixth switch circuit may include: a sixth n-channel transistor having a drain connected to the first actuator, a source connected to the first node, and a gate coupled to receive a first gate drive signal from the control circuitry; a twelfth transistor configured to selectively connect the gate of the sixth n-channel transistor to the source of the sixth n-channel transistor in order to configure the sixth n-channel transistor as a trans-diode during the pre-charge sub-phase; a thirteenth transistor configured to connect a body of the sixth n-channel transistor to ground when the sixth n-channel transistor is set by the first gate drive signal to be off; and a fourteenth transistor configured to connect the body of the sixth n-channel transistor to the source of the sixth n-channel transistor when the sixth n-channel transistor is set by the first gate drive signal to be on, during the pre-charge sub-phase, and to exploit the body-drain junction of the sixth n-channel transistor.

Also disclosed herein is a driver system for a differential piezoelectric actuator system, the driver system including: an inductor connected between first and second nodes; and a driver circuit comprising switches for selectively facilitating transfer of energy between first and second actuators of the differential piezoelectric actuator system and the inductor, and between a voltage supply node and the inductor.

The driver system includes control circuitry configured to determine whether a next phase in which to operate the driver circuit is a first charging phase or a first recovery phase, based upon feedback signals.

In the first charging phase, the control circuitry is configured to: in a first sub-phase, operate the switches to transfer energy from the first actuator to the inductor; in a second sub-phase, operate the switches to transfer energy from the voltage supply node to the inductor; in a third sub-phase, operate the switches to transfer energy from the inductor to the second actuator; and in a fourth sub-phase, operate the switches to cause the inductor to freewheel.

In the first recovery phase, the control circuitry is configured to: in a first sub-phase, operate the switches to transfer energy from the first actuator to the inductor; in a second sub-phase, operate the switches to transfer energy from the inductor to the voltage supply node; in a third sub-phase, operate the switches to transfer energy from the inductor to the second actuator; and in a fourth sub-phase, operate the switches to cause the inductor to freewheel.

Prior to the first sub-phase of the first charging phase and/or prior to the first sub-phase of the first recovery phase, the control circuitry is configured to operate the switches to perform a pre-charge sub-phase to place a given one of the switches connected to the first actuator near a zero-voltage switching condition.

The control circuitry may be configured to perform the pre-charge sub-phase by operating the switches to pre-charge a gate capacitance and other intrinsic capacitances of the given one of the switches connected to the first actuator and to pre-charge a parasitic capacitance seen at the first node.

The control circuitry may be configured to perform the pre-charge sub-phase by: in a first part, operate the switches to transfer energy from the voltage supply node to the inductor, and in a second part, operate the switches to transfer energy from the inductor to a gate capacitance of the given one of the switches connected to the first actuator and to a parasitic capacitance seen at the first node. A duration of the first part of the pre-charge sub-phase may be set by the control circuitry to be such that energy transferred from the voltage supply node to the inductor during the first part of the pre-charge sub-phase is equal to energy dissipated by the given one of the switches connected to the first actuator during the pre-charge sub-phase. A duration of the second part of the pre-charge sub-phase may be set by the control circuitry to be such that the energy stored in the inductor during the first part of the pre-charge sub-phase is fully transferred to the gate capacitance of the given one of the switches connected to the first actuator and the parasitic capacitance seen at the first node.

A duration of the second part of the pre-charge sub-phase may be set by the control circuitry based upon a zero crossing of an instantaneous value of an inductor current through the inductor.

The control circuitry may be configured to, during the pre-charge sub-phase, place the given one of the switches connected to the first actuator into a diode coupled configuration.

The control circuitry may be further configured to, in an additional recovery sub-phase occurring after the third sub-phase of the first charging phase and/or after the third sub-phase of the first recovery phase, operate the switches to transfer energy stored in a parasitic capacitance associated with the second node to the voltage supply node.

A duration of the additional recovery sub-phase may be set by the control circuitry based upon a zero crossing of an instantaneous value of an inductor current through the inductor.

The switches in the driver circuit may include: a first switch circuit connected between the first actuator and the first node; a second switch circuit connected between the first node and ground; a third switch circuit connected between the voltage supply node and the first node; a fourth switch circuit connected between the second node and ground; a fifth switch circuit connected between the voltage supply node and the second node; and a sixth switch circuit connected between the second node and the second actuator.

The control circuitry may be further configured to, immediately after the third sub-phase of the first charging phase and/or immediately after the third sub-phase of the first recovery phase, operate the switches to perform an additional recovery sub-phase to transfer energy stored in a parasitic capacitance associated with the second node to the voltage supply node.

The third switch circuit may include: a third n-channel transistor having a source connected to the voltage supply node, a drain connected to the first node, and a gate coupled to receive a third gate drive signal from the control circuitry; a first transistor configured to selectively connect the gate of the third n-channel transistor to the drain of the third n-channel transistor to configure the third n-channel transistor as a trans-diode to perform the additional recovery sub-phase; a second transistor configured to selectively connect a body of the third n-channel transistor to the drain of the third n-channel transistor to exploit an intrinsic body-source diode of the third n-channel transistor to perform the additional recovery sub-phase; a third transistor configured to connect the body of the third n-channel transistor to the voltage supply node when the third n-channel transistor is set by the third gate drive signal to be on; and a fourth transistor configured to connect the body of the third n-channel transistor to ground when the third n-channel transistor is set by the third gate drive signal to be off.

The fifth switch circuit may include: a fifth n-channel transistor having a source connected to the voltage supply node, a drain connected to the second node, and a gate coupled to receive a fifth gate drive signal from the control circuitry; a fifth transistor configured to selectively connect the gate of the fifth n-channel transistor to the drain of the fifth n-channel transistor to configure the fifth n-channel transistor as a trans-diode to perform the additional recovery sub-phase; a sixth transistor configured to selectively connect a body of the fifth n-channel transistor to the drain of the fifth n-channel transistor to exploit the intrinsic body-source diode of the fifth n-channel transistor to perform the additional recovery sub-phase; a seventh transistor configured to connect the body of the fifth n-channel transistor to the voltage supply node when the fifth n-channel transistor is set by the fifth gate drive signal to be on; and an eighth transistor configured to connect the body of the fifth n-channel transistor to ground when the fifth n-channel transistor is set by the fifth gate drive signal to be off.

The first switch circuit may include: a first n-channel transistor having a drain connected to the first actuator, a source connected to the first node, and a gate coupled to receive a first gate drive signal from the control circuitry; a ninth transistor configured to connect the gate of the first n-channel transistor to the source of the first n-channel transistor during the pre-charge sub-phase; a tenth transistor configured to connect a body of the first n-channel transistor to ground when the first n-channel transistor is set by the first gate drive signal to be off; and an eleventh transistor configured to connect the body of the first n-channel transistor to the source of the first n-channel transistor when the first n-channel transistor is set by the first gate drive signal to be on, when the pre-charge sub-phase is to be performed, and to exploit a body-drain junction of the first n-channel transistor.

The sixth switch circuit may include: a sixth n-channel transistor having a drain connected to the first actuator, a source connected to the first node, and a gate coupled to receive a first gate drive signal from the control circuitry; a twelfth transistor configured to connect the gate of the sixth n-channel transistor to the source of the sixth n-channel transistor during the pre-charge sub-phase; a thirteenth transistor configured to connect a body of the sixth n-channel transistor to ground when the sixth n-channel transistor is set by the first gate drive signal to be off; and a fourteenth transistor configured to connect the body of the sixth n-channel transistor to the source of the sixth n-channel transistor when the sixth n-channel transistor is set by the first gate drive signal to be on, when the pre-charge sub-phase is to be performed, and to exploit the body-drain junction of the sixth n-channel transistor.

The control circuitry may be configured to, immediately after the third sub-phase of the first charging phase and/or immediately after the third sub-phase of the first recovery phase, perform an additional recovery sub-phase to operate the switches to transfer energy stored in a parasitic capacitance associated with the second node to the voltage supply node.

The control circuitry may be configured to, during the additional recovery sub-phase, set a given one of the switches connected between the first node and the voltage supply node to conduct through a body diode of a transistor forming that given one of the switches.

### BRIEF DESCRIPTION OF THE DRAWINGS

FIG. 1 is a schematic block diagram of a prior art driver for a differential piezoelectric actuator.

FIG. 2 is a schematic block diagram of a driver for a differential piezoelectric actuator, together with control circuitry for the driver, as disclosed herein.

FIG. 3A shows the series of four sub-phases of a first charging phase in which the driver of FIG. 2 may be operated.

FIG. 3B shows the series of four sub-phases of a second charging phase in which the driver of FIG. 2 may be operated.

FIG. 4A shows graphs of inductor current and node currents of the driver of FIG. 2 when operating according to the first charging phase of FIG. 3A.

FIG. 4B shows graphs of inductor current and node currents of the driver of FIG. 2 when operating according to the second charging phase of FIG. 3B.

FIG. 5A shows the series of four sub-phases of a first recovery phase in which the driver of FIG. 2 may be operated.

FIG. 5B shows the series of four sub-phases of a second recovery phase in which the driver of FIG. 2 may be operated.

FIG. 6A shows graphs of inductor current and node currents of the driver of FIG. 2 when operating according to the first recovery phase of FIG. 5A.

FIG. 6B shows graphs of inductor current and node currents of the driver of FIG. 2 when operating according to the second recovery phase of FIG. 5B.

FIG. 7 is a table showing the relationship between the current state, error, reference sign, reference slope sign, and next state in which the driver of FIG. 2 is to be operated in.

FIG. 8 is a schematic block diagram of a first detailed embodiment of a driver for a differential piezoelectric actuator, together with control circuitry for the driver, as disclosed herein.

FIG. 9 is a series of graphs of voltage values of the driver of FIG. 8 during operation.

FIG. 10 is a graph of power spectral density of the output differential voltage of the driver of FIG. 8 during operation.

FIG. 11 is a schematic block diagram of a second detailed embodiment of a driver for a differential piezoelectric actuator including an integrated boost converter, together with control circuitry for the driver, as disclosed herein.

FIG. 12 shows a series of two sub-phases such as may be inserted into the charging phases or recovery phases of the driver of FIG. 11 so as to operate the driver as a boost converter.

FIG. 13 is a schematic block diagram of a driver for a differential piezoelectric actuator, together with control circuitry for the driver, as disclosed herein.

FIG. 14A shows the series of four sub-phases of a first recovery phase in which the driver of FIG. 13 may be operated.

FIG. 14B shows the series of four sub-phases of a second recovery phase in which the driver of FIG. 13 may be operated.

FIG. 15A shows graphs of inductor current and node currents of the driver of FIG. 13 when operating according to the first recovery phase of FIG. 14A.

FIG. 15B shows graphs of inductor current and node currents of the driver of FIG. 13 when operating according to the second recovery phase of FIG. 14B.

FIG. 16 is a schematic block diagram of a driver for a differential piezoelectric actuator, as disclosed herein.

FIG. 17 is a diagram showing the series of sub-phases of a first charging phase in which the driver of FIG. 16 may be operated, including pre-charge and additional recovery sub-phases described herein.

FIG. 18A shows the series of the first and second parts of a pre-charge sub-phase of a first charging phase in which the driver of FIG. 16 may be operated.

FIG. 18B shows the series of the first and second parts of a pre-charge sub-phase of a second charging phase in which the driver of FIG. 16 may be operated.

FIG. 18C shows the series of the first and second parts of a pre-charge sub-phase of a first recovery phase in which the driver of FIG. 16 may be operated.

FIG. 18D shows the series of the first and second parts of a pre-charge sub-phase of a second recovery phase in which the driver of FIG. 16 may be operated.

FIG. 19 is a graph showing the power dissipation through the switch connecting the actuator to the inductor terminal (i.e., S1 during the first sub-phase of the first charging phase) and energy draw from the battery with and without the pre-charge sub-phase.

FIG. 20A shows an additional recovery sub-phase of a first charging phase in which the driver of FIG. 16 may be operated.

FIG. 20B shows an additional recovery sub-phase of a second charging phase in which the driver of FIG. 16 may be operated.

FIG. 20C shows an additional recovery sub-phase of a first recovery phase in which the driver of FIG. 16 may be operated.

FIG. 20D shows an additional recovery sub-phase of a second recovery phase in which the driver of FIG. 16 may be operated.

FIG. 21 is a chart showing the power dissipation and energy draw from the battery with and without the additional recovery sub-phase.

### DETAILED DESCRIPTION

The following disclosure enables a person skilled in the art to make and use the subject matter disclosed herein. The general principles described herein may be applied to embodiments and applications other than those detailed above without departing from the spirit and scope of this disclosure. This disclosure is not intended to be limited to the embodiments shown, but is to be accorded the widest scope consistent with the principles and features disclosed or suggested herein.

Disclosed herein with initial reference to FIG. 2 is a driver 10 for a differential piezoelectric actuator PZT1, PZT2, together with control circuitry 21 for the driver 10.

The differential piezoelectric actuator PZT1, PZT2 is represented as two capacitances respectively connected between nodes A1, A2 and ground because, from an electrical point of view, a piezoelectric actuator may be modeled as a capacitor at a first order approximation. Appreciate though that instead of a differential piezoelectric actuator, the references PZT1, PZT2 may represent any differential capacitive load.

The driver 10 includes a first driver circuit 11 connected between node A1 and node L1, and a second driver circuit 12 connected between node A2 and node L2. The first and second driver circuits 11 and 12 are powered between a battery Vbatt and ground. An external inductor L is connected between nodes L1 and L2. The driver circuits 11, 12 are integrated components (e.g., integrated within an integrated circuit), and the inductor L is an external component.

The driver circuit 11 includes a switch S3 connected between the battery Vbatt and node L1, a switch S2 connected between node L1 and ground, and a switch S1 connected between node A1 and node L1. The driver circuit 12 includes a switch S5 connected between a battery Vbatt and node L2, a switch S4 connected between node L2 and ground, and a switch S6 connected between node A2 and node L2.

The control circuitry 21 is clocked by the clock signal CK, which is the system clock at which the digital blocks operate. This is separate from the switching frequency (Fsw) at which the switches S1-S6 are operated; this switching frequency may be derived from the clock signal CK. By way of example, the clock frequency CK could be 20 MHz, and the switching frequency could be F_{CK}/20=1 MHz.

The control circuitry 21 receives as input the continuous time (instantaneous) value of the current I[L] through the inductor L. The control circuitry 21 averages the continuous time value of the current I[L] over a switching period (Tsw) to produce I_AVG[L], which as an example in the case of F_{CK}/20=1 MHz would be an average over as 1 μs switching period. The control circuitry 21 also elaborates the continuous time value of the current I[L] to determine zero crosses thereof, the use of which is described below. The control circuitry 21 also receives as input a first differential voltage V[VA1−VA2] that is the difference between the voltage VA1 at voltage A1 and the voltage VA2 at voltage A2, and a common mode voltage between nodes A1, A2 represented as V[(VA1+VA2)/2]. The control circuitry 21 also receives as input a common mode reference voltage vcm_REF_DATA (represented digitally) and a differential reference voltage vdm_REF_DATA (represented digitally). The differential reference voltage vdm_REF_DATA may represent a sawtooth signal, or may represent other time varying signals such as sinusoids, which is enabled by the flexibility provided by the control circuitry 21 and driver 10 described herein.

The control circuitry 21 operates, based upon its inputs, to control the switches S1-S6 so as to operate the driver 10 in charging phases and recovery phases, with one charging phase or one recovery phase to be performed per switching period Tsw (which is a design parameter, and is a multiple of the clock period Tck). Charging phases occur when charge is to be transferred from PZT1 to PZT2, or from PZT2 to PZT1, and there is insufficient charge from the transferor actuator to fully charge the transferee actuator. Recovery phases occur when charge is to be transferred from PZT1 to PZT2, or from PZT2 to PZT1, and there is more than sufficient charge from the transferor actuator to fully charge the transferee actuator.

Insufficient charge or more than sufficient charge is related to shape of the voltage wave that is to be applied to PZT1 and PZT2. In greater detail, at each switching period, charge is taken from PZT1 and provided to PZT2. The charge taken from PZT1 can be mathematically represented as

$$\frac{1}{2} \times {C}_{PZT} \times {[ {V}_{PZT 1} ( t 1 ) - {V}_{PZT 1} ( t 0 ) ]}^{2} ,$$

and the charge provided to PZT2 can be represented as mathematically represented as

$$\frac{1}{2} \times {C}_{PZT} \times {[ {V}_{PZT 2} ( t 1 ) - {V}_{PZT 2} ( t 0 ) ]}^{2} .$$

Since Vpzr1 is different than VPZT2, and since some sources for energy losses will be involved in this charge transfer, the imbalance between the two is transferred from or back to the battery Vbatt. This charge imbalance is therefore related to the variation of the potential voltage to be imposed on the actuators PZT1, PZT2 so that the differential voltage V[VA1−VA2] tracks the differential reference voltage vdm_REF_DATA during operation.

The charging phases include C12 (in which energy from the piezoelectric actuator PZT1, as well as energy from the battery Vbatt, is transferred to the inductor L and then the energy stored in the inductor L is transferred to the piezoelectric actuator PZT2) and C21 (in which energy from the piezoelectric actuator PZT2, as well as energy from the battery Vbatt, is transferred to the inductor L and then the energy from the inductor L is transferred to the piezoelectric actuator PZT1). The recovery phases include R12 (in which energy from the piezoelectric actuator PZT1 is transferred to the inductor L and the energy from the inductor L is transferred to the piezoelectric actuator PZT2 while remainder energy within the inductor L is transferred to the battery Vbatt), and R21 (in which energy from the piezoelectric actuator PZT2 is transferred to the inductor L and the energy from the inductor L is transferred to the piezoelectric actuator PZT1 while remainder energy within the inductor L is transferred to the battery Vbatt).

The charging and recovery phases will now be described in detail, and thereafter, the operation of the control circuitry 21 to select which charging phase and which recovery phase to operate the driver 10 in, based upon current inputs, will be described.

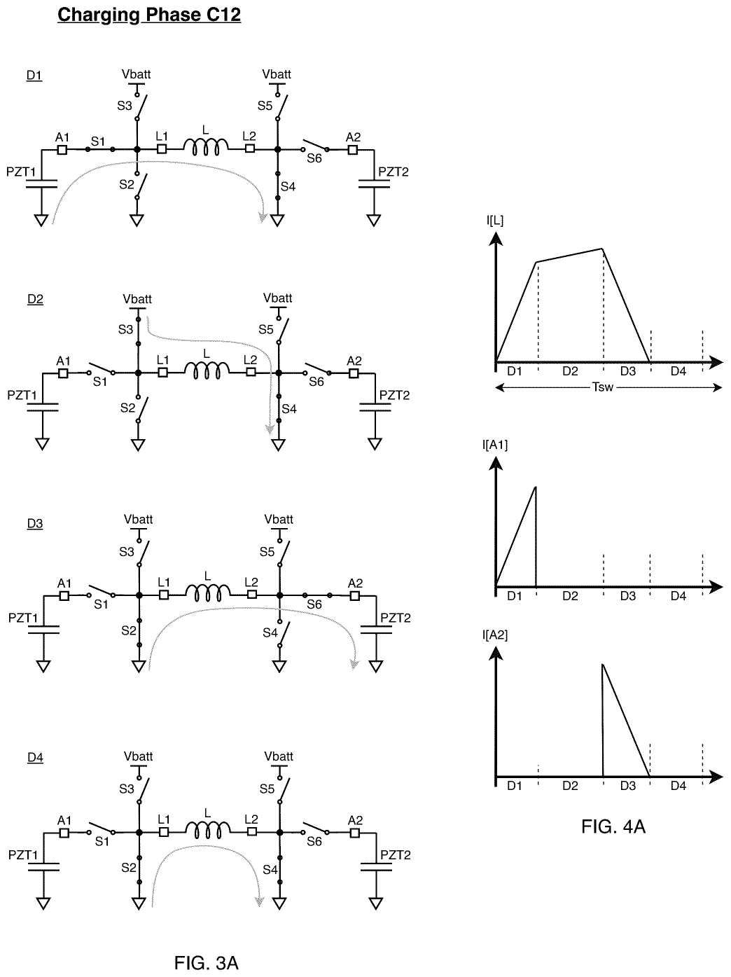

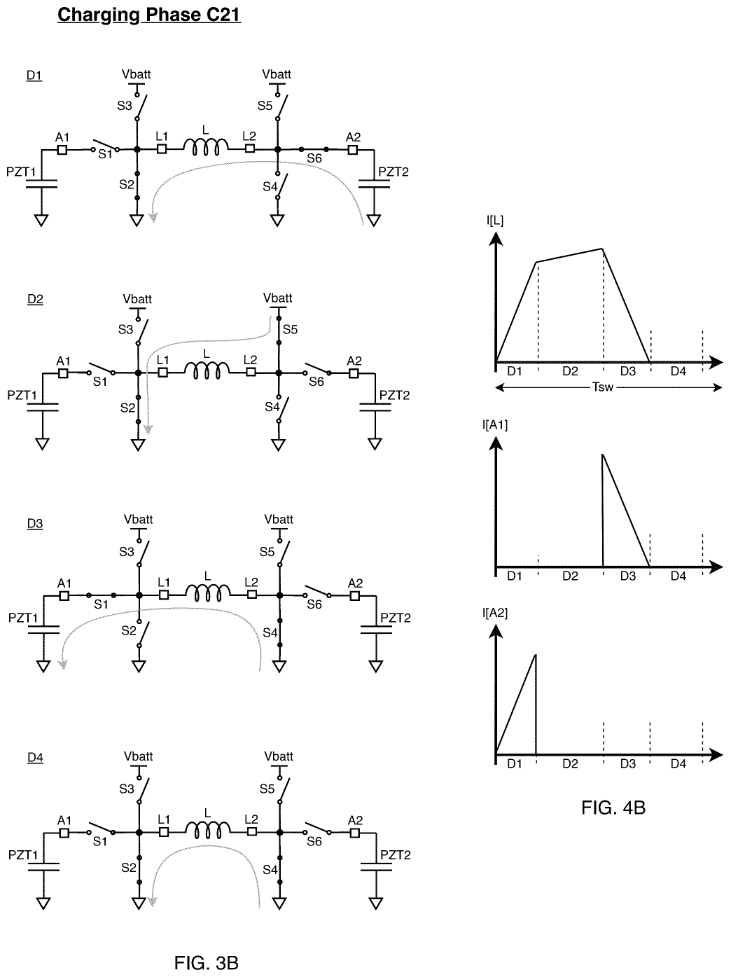

Charging phase C12 is now described with reference to FIGS. 3A and 4A. Charging phase C12 is separated into three sub-phases D1, D2, and D3, followed by a sub-phase D4. In phase C12 sub-phase D1, switches S1 and S4 are closed, while the other switches are kept open, having the effect of transferring energy from the piezoelectric actuator PZT1 to the inductor L for storage. This D1 sub-phase can be observed in FIG. 4A, where the current I[L] through the inductor L rises with a slope of VA1/L, and the current I[A1] flowing out of PZT1 rises with a slope of VA1/L.

Next, in phase C12 sub-phase D2, switches S3 and S4 are closed, while the other switches are kept open, having the effect of transferring energy from the battery Vbatt to the inductor L. The inductor current I[L] rises with a slope of Vbatt/L as a result, as can be observed in FIG. 4A—since the voltage stored across PZT1 is actually greater than the battery voltage Vbatt, notice that the slope Vbatt/L is less than the slope VA1/L (until VA1 is greater than Vbatt) in this example. Note that in other examples, the voltage stored across PZT1 can be lower than Vbatt, in which case the slope VA1/L will be lower than Vbatt/L-therefore, the voltages stored across PZT1 and PZT2 can be close to ground, which is not possible with conventional drivers in which a large amount of headroom with respect to ground is to be maintained.

In phase C12 sub-phase D3, switches S2 and S6 are closed, while the other switches are kept open, having the effect of transferring energy from the inductor L to the piezoelectric actuator PZT2. Since the inductor current I[L] is flowing from the inductor L to PZT2 at this point, the inductor current I[L] falls with a slope of −VA2/L and the current I[A2] flowing into PZT2 falls with a slope of −VA2/L during sub-phase D3, as shown in FIG. 4A.

In phase C12 sub-phase D4, switches S2 and S4 are closed while the other switches are kept open, with the result being that the current is kept fixed, ideally at zero, ready for the next period in which the current may be reversed or not.

Charging phase C21 is effectively the inverse of charging phase C12, and is now described with reference to FIGS. 3B and 4B. Charging phase C21 is separated into three sub-phases D1, D2, and D3, followed by a sub-phase D4. In phase C21 sub-phase D1, switches S2 and S6 are closed, while the other switches are kept open, having the effect of transferring energy from the piezoelectric actuator PZT2 to the inductor L for storage. This D1 sub-phase can be observed in FIG. 4B, where the current I[L] through the inductor L rises with a slope of VA2/L, and the current I[A2] flowing out of PZT1 rises with a slope of VA2/L.

Next, in phase C21 sub-phase D2, switches S2 and S5 are closed, while the other switches are kept open, having the effect of transferring energy from the battery Vbatt to the inductor L. The inductor current I[L] rises with a slope of Vbatt/L as a result, as can be observed in FIG. 4B—since the voltage stored across PZT2 is actually greater than the battery voltage Vbatt, notice that the slope Vbatt/L is less than the slope VA2/L (until VA2 is greater than Vbatt) in this example.

In phase C21 sub-phase D3, switches S1 and S4 are closed, while the other switches are kept open, having the effect of transferring energy from the inductor L to the piezoelectric actuator PZT1. Since the inductor current I[L] is flowing from the inductor L to PZT1 at this point, the inductor current I[L] falls with a slope of −VA1/L and the current I[A1] flowing into PZT1 falls with a slope of −VA1/L during sub-phase D3, as shown in FIG. 4B.

In phase C21, sub-phase D4, switches S2 and S4 are closed while the other switches are kept open, with the result being that the current is kept fixed, ideally at zero, ready for the next period in which the current may be reversed or not.

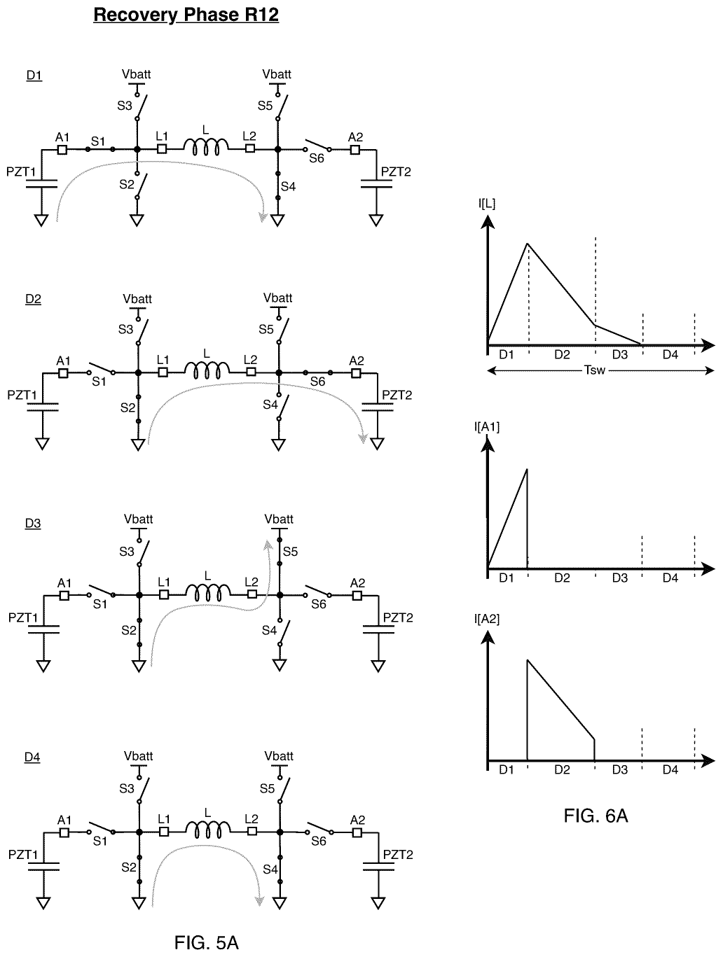

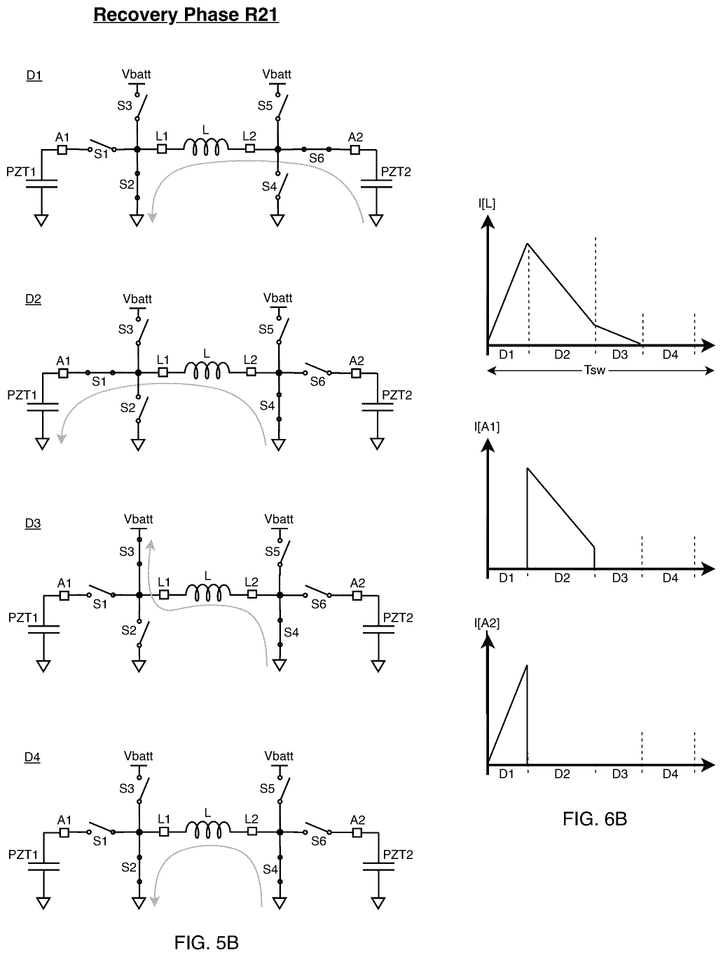

Recovery phase R12 is now described with reference to FIGS. 5A and 6A. Recovery phase R12 is separated into three sub-phases D1, D2, and D3, followed by sub-phase D4. In phase R12 sub-phase D1, switches S1 and S4 are closed, while the other switches are kept open, having the effect of transferring energy from the piezoelectric actuator PZT1 to the inductor L for storage. This D1 sub-phase can be observed in FIG. 6A, where the current I[L] through the inductor L rises with a slope of VA1/L, and the current I[A1] flowing out of PZT1 rises with a slope of VA1/L.

Next, in phase R12 sub-phase D2, switches S2 and S6 are closed, while the other switches are kept open, having the effect of transferring energy from the inductor L to the piezoelectric actuator PZT2. Since the inductor current I[L] is flowing from the inductor L to PZT2 at this point, the inductor current I[L] falls with a slope of −VA2/L and the current I[A2] flowing into PZT2 falls with a slope of −VA2/L during sub-phase D2, as shown in FIG. 6A.

In phase R12 sub-phase D3, switches S2 and S5 are closed, while the other switches are kept open, having the effect of transferring remainder energy left in the inductor L to the battery D3, with the inductor current I[L] falling with a slope of −Vbatt/L as a result as shown in FIG. 6A.

In phase R12, sub-phase D4, switches S2 and S4 are closed while the other switches are kept open, with the result being that the current is kept fixed, ideally at zero, ready for the next period in which the current may be reversed or not.

Recovery phase R21 is effectively the inverse of recovery phase R12, and is now described with reference to FIGS. 5B and 6B.

Recovery phase R21 is separated into three sub-phases D1, D2, and D3, followed by sub-phase D4. In phase R21 sub-phase D1, switches S2 and S6 are closed, while the other switches are kept open, having the effect of transferring energy from the piezoelectric actuator PZT2 to the inductor L for storage. This D1 sub-phase can be observed in FIG. 6B, where the current I[L] through the inductor L rises with a slope of VA2/L, and the current I[A2] flowing out of PZT2 rises with a slope of VA2/L.

Next, in phase R21 sub-phase D2, switches S1 and S4 are closed, while the other switches are kept open, having the effect of transferring energy from the inductor L to the piezoelectric actuator PZT1. Since the inductor current I[L] is flowing from the inductor L to PZT1 at this point, the inductor current I[L] falls with a slope of −VA1/L and the current I[A1] flowing into PZT1 falls with a slope of −VA1/L during sub-phase D2, as shown in FIG. 6B.

In phase R21 sub-phase D3, switches S3 and S4 are closed, while the other switches are kept open, having the effect of transferring remainder energy left in the inductor L to the battery D3, with the inductor current I[L] falling with a slope of −Vbatt/L as a result as shown in FIG. 6B.

When phase R21 sub-phase D4 is performed, switches S2 and S4 are closed while the other switches are kept open, with the result being that the current is kept fixed, ideally at zero, ready for the next period in which the current may be reversed or not.

Operation of the control circuitry 21 to select which charging phase and which recovery phase to operate the driver 10 in, based upon current inputs, will be described. The voltage V[VA1−VA2] is the differential output voltage, and the difference between the differential output voltage V[VA1−VA2] and the differential reference voltage vdm_REF_DATA can be referred to as the “error”. The current sign of the differential reference voltage vdm_REF_DATA can be referred to as the “reference sign”, and the current sign of the slope of the differential reference voltage vdm_REF_DATA can be referred to as the “reference slope sign”.

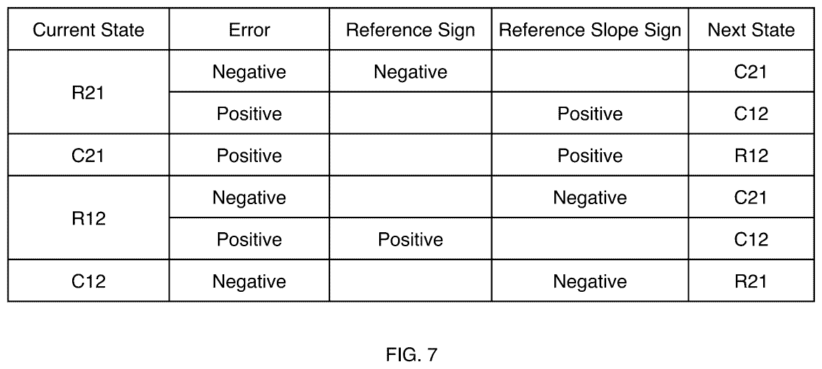

A single switching period is represented in the graphs of FIGS. 4A-4B and 6A-6B. At the end of each switching period, the control circuitry 21 determines which phase (either a charging phase or a recovery phase, and in which direction charge transfer occurs, whether it be from PZT1 to PZT2 or from PZT2 to PZT1) in which to control the driver 10 during the next switching period, based upon the current phase, the error, the reference sign, and the reference slope sign. The relationships between the current phase, error, reference sign, reference slope sign, and the next phase are now described with additional reference to the table of FIG. 7.

If the current phase is the recovery phase R21 and both the error and the reference sign are negative, then the next phase that the control circuitry 21 controls the driver 10 to be in is the charging phase C21.

If the current phase is the recovery phase R21 and both the error and the reference slope sign are both positive, then the next phase that the control circuitry 21 controls the driver 10 to be in is the charging phase C12.

If the current phase is the charging phase C21 and both the error and reference slope sign are positive, then the next phase that the control circuitry 21 controls the driver 10 to be in is the recovery phase R12.

If the current phase is the recovery phase R12 and both the error and reference slope sign are negative, then the next phase that the control circuitry 21 controls the driver 10 to be in is the charging phase C21.

If the current phase is the recovery phase R12 and both the error and reference sign are positive, then the next phase that the control circuitry 21 controls the driver 10 to be in is the recovery phase R12.

If the current phase is the charging phase C12 and both the error and reference slope sign are negative, then the next phase that the control circuitry 21 controls the driver 10 to be in is the recovery phase R21.

The above relationships between the current state, error, reference sign, reference slope sign set the next state as shown in table form in FIG. 7. If none of the conditions in the table of FIG. 7 can be verified, then the next state will be the current state (e.g., the state will not change).

The state change condition from recovery (either R12 or R21) to charge (C21 or C12) can be related to the residual energy after the D2 sub-phase. Specifically, the time duration of sub-phase D3 in the recovery phase is related to the extra energy stored in the inductor L, which in this sub-phase is transferred back to the battery. When the time duration of sub-phase D3 in the recovery phase approaches zero, it means that extra energy is not stored in the inductor L and therefore the next phase is to be a charging phase. Therefore, a state change condition can be added to the one described before, with this being related to state change from recovery to charge (R21 to C12 or R12 to C21) and the condition is the time duration of sub-phase D3 which approaches zero.

The pulse-widths of sub-phases D1 and D2 are determined by the control circuitry 21 based upon the value of the signals it receives as feedback, namely the differential voltage V[VA1−VA2] and common mode voltage V[(VA1+VA2)/2] as well as the continuous time value of the inductor current I[L] to be averaged over one period (i.e., I_AVG[L]). In general though, for whatever phase is to be performed, each feedback signal may be utilized. From a mathematical point of view, the control circuitry 21 effectively use the voltages VA1 and VA2, but derives them from the measured differential and common mode voltages. This because it is more advantageous to implement a single double-ended differential readout circuit rather than two single-ended readout circuits.

The pulse-width D3 is instead defined by looking at the instantaneous value of the inductor current I[L] and, more precisely, by looking for the zero crossing.

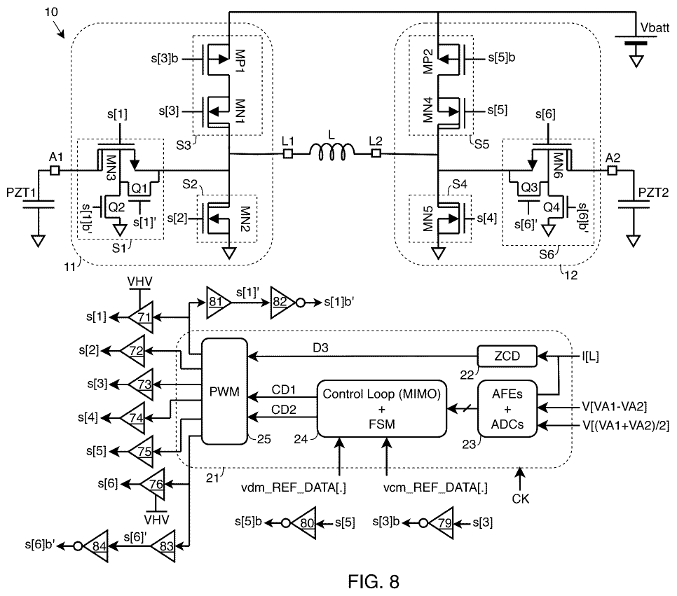

A first detailed embodiment of the driver 10 and control circuitry 21 is now described with reference to FIG. 8. In this embodiment, the switch S3 may be formed by: a first p-channel transistor MP1 having a source connected to the battery Vbatt, a drain connected to a source of a first n-channel transistor MN1, and a gate receiving a gate drive signal s[3] b; and the first high-voltage n-channel transistor MN1 having its source connected to the drain of MP1, its drain connected to node L1, and its gate receiving a gate drive signal s[3], the gate drive signal s[3] b being a complement of the gate drive signal s[3]. The bulk of MP1 is connected to the source of MP1, and the bulk of MN1 is connected to the source of MN1,

The switch S2 may be formed by a second high-voltage n-channel transistor MN2 having its drain connected to node L1, its source connected to ground, and its gate receiving a gate drive signal s[2]. The bulk of MN2 is connected to the source of MN2.

The switch S1 may be formed by a third high-voltage n-channel transistor MN3 having its drain connected to node A1, its source connected to node L1, and its gate receiving a gate drive signal s[1]. The n-channel transistor MN3 may be a high-voltage transistor, with the gate drive signal s[1] being a high voltage drive signal (e.g., on the order of 50V+). The bulk of MN3 is connected to the source of MN3 by switch Q1 when a low-voltage domain version s[1]′ of the gate drive signal s[1] is at a logic high, and is connected to ground by switch Q2 when the inverse s[1] b′ of the low-voltage domain gate drive signal s[1]′ is at a logic high.

The switch S5 may be formed by: a second p-channel transistor MP2 having a source connected to the battery Vbatt, a drain connected to a source of a fourth high-voltage n-channel transistor MN4, and a gate receiving a gate drive signal s[5] b; and the fourth n-channel transistor MN4 having its source connected to the drain of MP2, its drain connected to node L2, and its gate receiving a gate drive signal s[5], the gate drive signal s[5] b being a complement of the gate drive signal s[5]. The bulk of MP2 is connected to the source of MP2, and the bulk of MN4 is connected to the source of MN4.

The switch S4 may be formed by a fifth high-voltage n-channel transistor MN5 having its drain connected to node L2, its source connected to ground, and its gate receiving a gate drive signal s[4]. The bulk of MN5 is connected to the source of MN5.

The switch S6 may be formed by a sixth n-channel transistor MN6 having its drain connected to node A2, its source connected to node L2, and its gate receiving a gate drive signal s[6]. The n-channel transistor MN6 may be a high-voltage transistor, with the gate drive signal s[6] being a high voltage drive signal (e.g., on the order of 50V+). The bulk of MN6 is connected to the source of MN6 by switch Q3 when a low-voltage domain version s[6]′ of the gate drive signal s[6] is at a logic high, and is connected to ground by switch Q4 when the inverse s[6] b′ of the low-voltage domain gate drive signal s[6]′ is at a logic high.

The above described transistors may be formed from any technology suitable to produce transistors capable of withstanding the voltages to be utilized for the driver design.

The control circuitry 21 includes a zero cross detector (ZCD) 22 that receives the current I[L] and asserts a control signal D3 when the current I[L] crosses zero. Respective analog front ends (AFEs) and analog to digital converters (ADCs) within the control circuitry 21, collectively reference 23, receive the differential voltage V[A1-A2] and the common mode voltage V[(A1+A2)/2], digitally filtering the results in appropriate bandwidths, and provide them as output to a multi-input multi-output (MIMO) control loop and finite state machine (FSM) within the control circuitry 21, collectively reference 24. The MIMO control loop and FSM 24 also receives the average inductor current I_AVG[L] over one switching period when it is to be evaluated for whatever phase is to be performed. The MIMO control loop/FSM 24 also receives the common mode reference voltage vcm_REF_DATA and the differential reference voltage vdm_REF_DATA as input.

The MIMO control loop/FSM 24 generates the control values CD1, CD2 as output based upon its inputs. In particular the FSM 24, by looking at the relationships between the current state, error, reference sign, reference slope sign, sets the next state as shown in table form in FIG. 7. If none of the conditions in the table of FIG. 7 can be verified, then the next state will be the current state (e.g., the state will not change). D3 is defined by looking at the instantaneous value of the inductor current I[L] and, more precisely, by looking for a zero crossing thereof.

A pulse width modulation (PWM) circuit 25 receives the control values CD1, CD2, and the signal D3, and, based on that, generates the gate drive signals s[1], s[2], s[3], s[4], s[5], s[6].

The gate drive signals s[1] and s[6] are passed through high-voltage drivers 71, 76 to become high-voltage domain signals, while the gate drive signals s[2], and s[4] are passed through standard drivers 72, 74, while the gate drive signals s[3] and s[5] are passed through boot-strapped drivers 73 and 75 that drive s[3] and s[5] to values higher than Vbatt. The gate drive signal s[3] b is generated by passing the gate drive signal s[3] through an inverter 79, and the gate drive signal s[5] b is generated by passing the gate drive signal s[5] through an inverter 80. The low-voltage domain gate drive signal s[1]′ is generated by the PWM circuit 25 as having the same logic level as s[1], and is passed through a standard gate driver 81 to an inverter 82 to thereby generate the low-voltage domain gate drive signal s[1] b′. The low-voltage domain gate drive signal s[6]′ is generated by the PWM circuit 25 as having the same logic level as s[6], and is passed through a standard gate driver 83 to an inverter 84 to thereby generate the low-voltage domain gate drive signal s[6] b′.

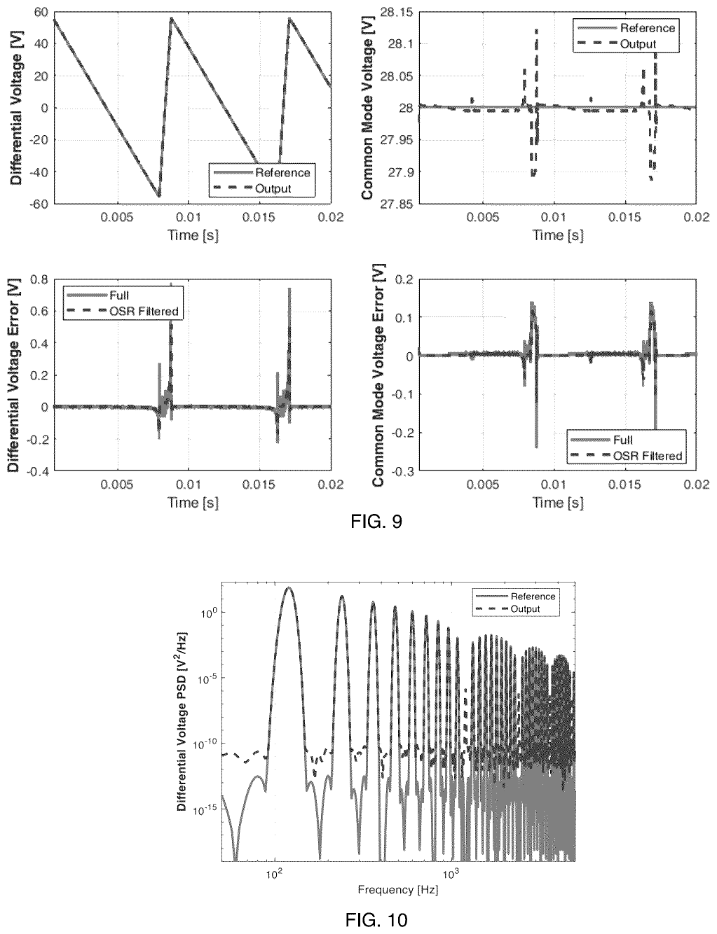

Graphs of values of voltages within the driver 10 are seen in FIG. 9, where it can be observed that the control is sufficient for the differential output voltage to well match the reference differential voltage, and for the common mode voltage to well match the reference common mode voltage. A graph of power spectral density can be seen in FIG. 10, where it can be seen that the output PSD well matches the reference.

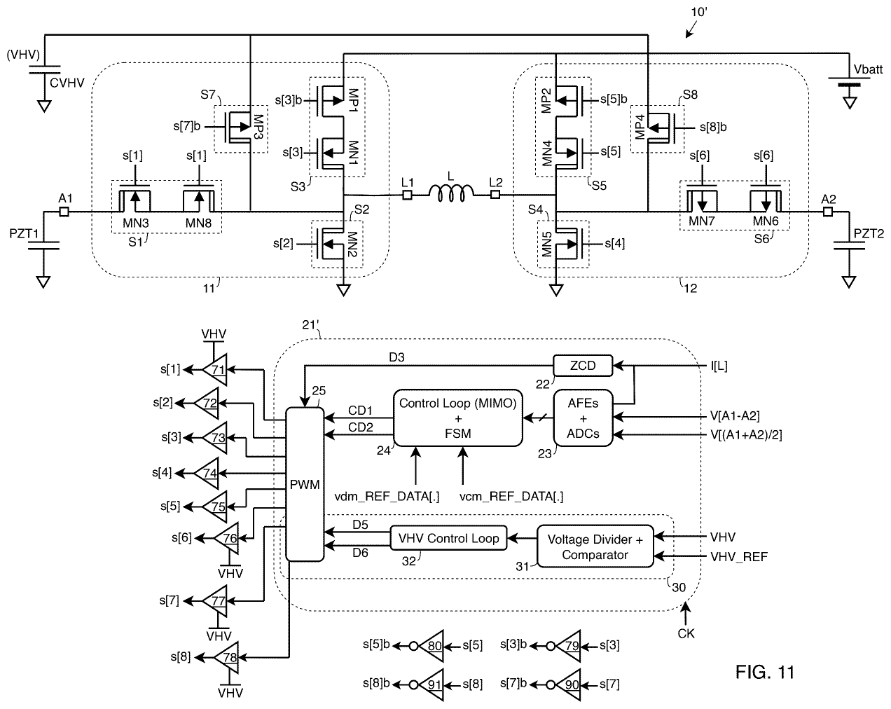

In the above-described embodiment, the high voltage VHV is generated by a boost converter external to the driver 10. However, the inductor L already present within the driver 10 may be exploited in another embodiment to be part of a boost converter internal to the driver, as now described with reference to the driver 10′ of FIG. 11. The driver 10′ contains the additions of a switch S7 connected between node L1 and a capacitor CVHV across which the high voltage VHV (on the order of 50+V) is formed, as well as a switch S8 connected between node L2 and the capacitor CVHV. The switch S7 is formed by a high-voltage p-channel transistor MP3 having its source connected to the capacitor CVHV, its drain connected to node L1, and its gate receiving a gate drive signal s[7] b. The bulk of MP3 is connected to the source of MP3. The switch S8 is formed by a high-voltage p-channel transistor MP4 having its source connected to the capacitor CVHV, its drain connected to node L2, and its gate receiving a gate drive signal s[8] b. The bulk of MP4 is connected to the source of MP4. In addition, in the driver 10′, the switch S1 includes an n-channel transistor MN8 connected between the n-channel transistor MN3 and node L1, with MN8 having its source connected to the source of MN3, its drain connected to node L1, and its gate also receiving the gate drive signal s[1]. The bulk of MN8 is connected to the source of MN8, and here note that the bulk of MN3 is connected to the source of MN3 Furthermore, in the driver 10′, the switch S6 includes an n-channel transistor MN7 connected between the n-channel transistor MN6 and node L2, with MN7 having its source connected to the source of MN6, its drain connected to node L2, and its gate also receiving the gate drive signal s[6]. The bulk of MN7 is connected to the source of MN7, and here note that the bulk of MN6 is connected to the source of MN6.

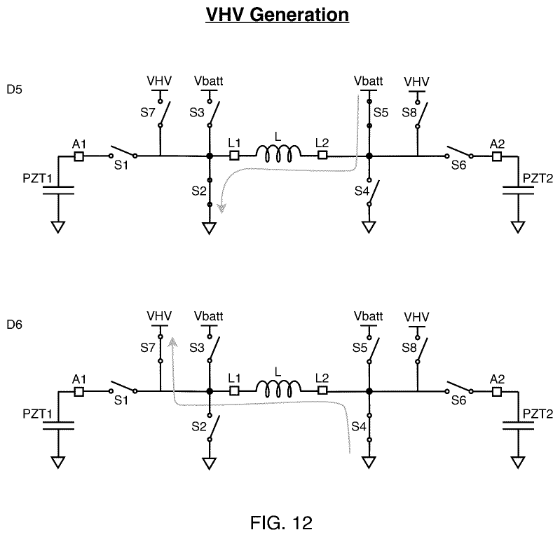

The specifics of the control circuitry 21′ for this embodiment will be described below, but first the VHV generation sub-phases D5 and D6 in which the control circuitry 21′ operates the driver 10′ during each switching period will now be described with additional reference to FIG. 12. Note that in this embodiment, sub-phase D4 is performed after D6. More precisely, the sub-phase D4 is performed whenever (D1+D2+D3+D5+D6)*Tsw<Tsw. If so, the sub-phase D4 is performed after D6 and its duration will be D4=1−(D1+D2+D3+D5+D6), thus covering the possible remainder time from the end of the sub-phase D6 to the end of Tsw.

In VHV generation sub-phase D5, the control circuitry 21′ closes switches S2 and S5 while leaving the other switches open. As a result, current flows from the battery Vbatt into the inductor L, generating a magnetic field and thereby storing energy in the inductor L. In VHV generation sub-phase D6, the control circuitry 21′ closes switches S4 and S7 while leaving the other switches open. The flow of current in the inductor from nodes L2 to L1 falls, and the strength of the magnetic field collapses as the stored energy is converted to current to attempt to maintain the current output from the inductor L. As a result, node L2 goes positive, meaning that the voltage across the inductor L from node L1 to node L2 is in series with the voltage being formed across capacitor CVHV, thereby providing a boosted voltage VHV to the capacitor CVHV which is greater than the battery voltage Vbatt. As such, generation sub-phases D5 and D6 serve to cause the driver 10′ to operate as a boost converter. It should be appreciated that this pattern of operation in the generation sub-phases D5 and D6 is but a possibility, and that in fact, VHV can be generated through different switching patterns—for example, in sub-phase D5, switches S2 and S5 could be closed while in sub-phase D6, switches S5 and S7 are closed.

Returning to the control circuitry 21′, the control circuitry 21′ additionally includes a boost controller 30 that generates control signals D5 and D6 from which the PWM circuit 25 generates the gate drive signals s[7] and s[8] according to the duration of the control signals D5 and D6. The boost controller 30 includes a comparator 30 that compares the current voltage VHV formed across the capacitor CVHV to a reference high voltage VHV_REF and asserts its output when VHV becomes equal to VHVREF. A control loop 32 receives the output of the comparator 30 and from it generates the control signals D5 and D6.

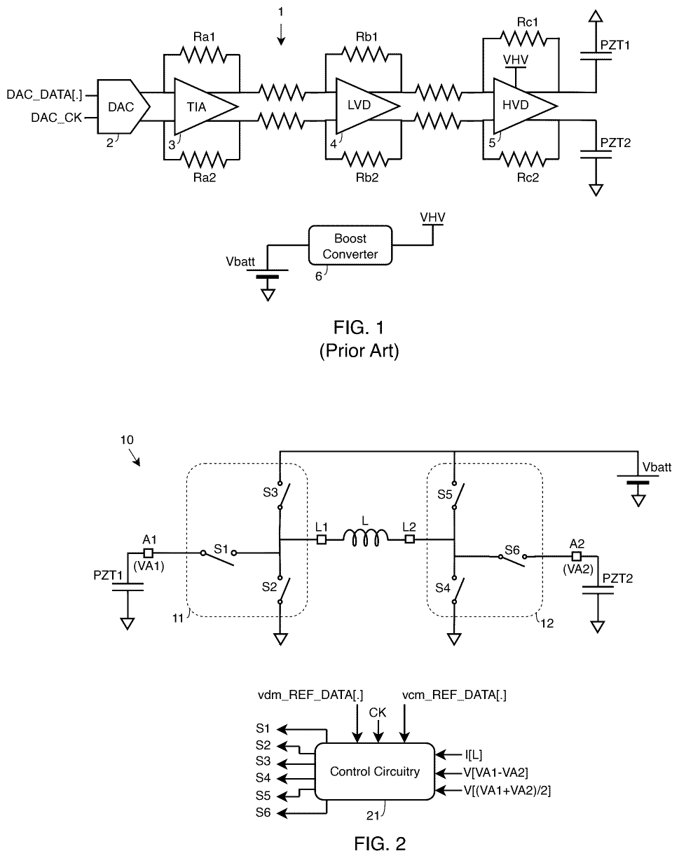

Advantages of the driver 10, 10′ designs described above will now be described. First off, efficiency is high due to the transfer of energy between the actuators PZT1 and PZT2 instead of the discharge of that energy to ground as well as the recovery by the battery of excess energy stored in the inductor L, without the energy consumption that would be caused by the quiescent currents in the various amplifiers of prior art designs (for example the HVD 5 of FIG. 1). Indeed, the limit on efficiency in these designs is simply that imposed by real world devices, such as the on-resistances of the devices forming the switches, the resistance of the inductor L, and the power consumption involved with the generation of the high voltage VHV.

Still further, the value of the capacitances of the actuators PZT1 and PZT2 is not a concern for stability or bandwidth because the use of a high voltage amplifier in the prior art is eliminated by the designs described herein. In addition, the designs described herein permit the increase of output full-scale, and the output differential voltage V[VA1−VA2] is effectively oversampled, which can be exploited in order to increase bandwidth and achieve increased output accuracy.

This ability to increase bandwidth permits the selection of the switching frequency as a trade-off between accuracy and power-consumption, and permits the driver to be used to drive a resonant device (e.g., micromirror).

While static power consumption of the components other than the driver is to be taken into account, the reduction in power consumption by the driver provides for an overall strong reduction in power consumption compared to prior systems utilizing prior drivers. In addition, assuming the control loop 32 is robust, feedback signals other than the differential output voltage have relaxed accuracy requirements. Noise performance is increased as well, with the relatively low noise present being related to PWM jitter and the driving of the switches as well as the noise of the feedback circuit.

It is clear that modifications and variations may be made to what has been described and illustrated herein, without thereby departing from the scope of this disclosure, as defined in the annexed claims. For example, in the embodiments described, the timing in the recovery phase R12 when switching from sub-phase D1 (with switches S1 and S4 closed) to sub-phase D2 (with switches S2 and S5 closed) is to be precise due to the fact that switch S5 is to close substantially simultaneously to the opening of switch S4. This is performed to provide for the current across the inductor L to flow continuously without interruption. If this switchover from sub-phase D1 to sub-phase D2 is performed incorrectly, the abrupt interruption in inductor current may cause a high voltage to appear at node L2, potentially causing damage. These same considerations, naturally, also apply to the recovery phase R21.

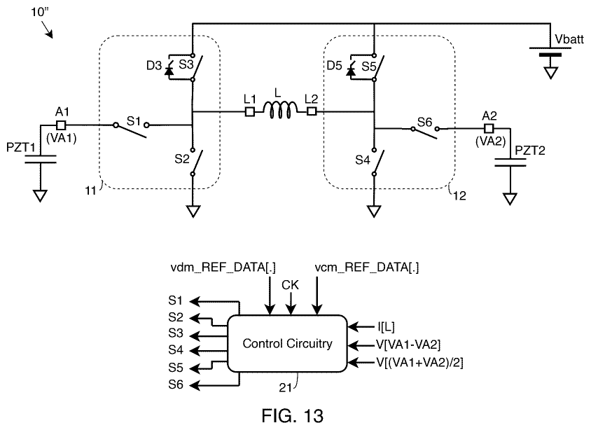

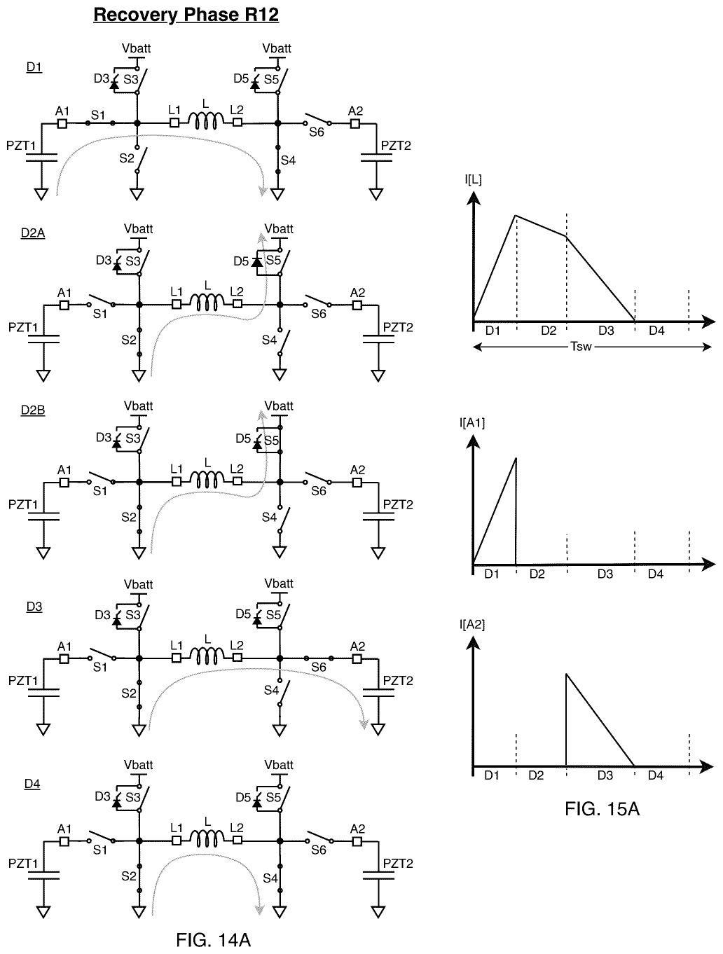

Therefore, to facilitate an embodiment in which more imprecise timing may be used, the embodiment of FIG. 13 was developed. The difference between the embodiments of FIG. 13 and FIG. 2 is that in the embodiment of FIG. 13, the switch S3 is a MOS transistor which includes an intrinsic body diode D3 having its anode connected to node L1 and its cathode connectable to the battery voltage Vbatt, and the switch S5 is a MOS transistor which includes an intrinsic body diode D5 that similarly has its anode connected to node L2 and its cathode connectable to the battery voltage Vbatt. Appreciate that the body diodes are intrinsic to the structure of the MOS devices, as stated, and are not discrete devices.

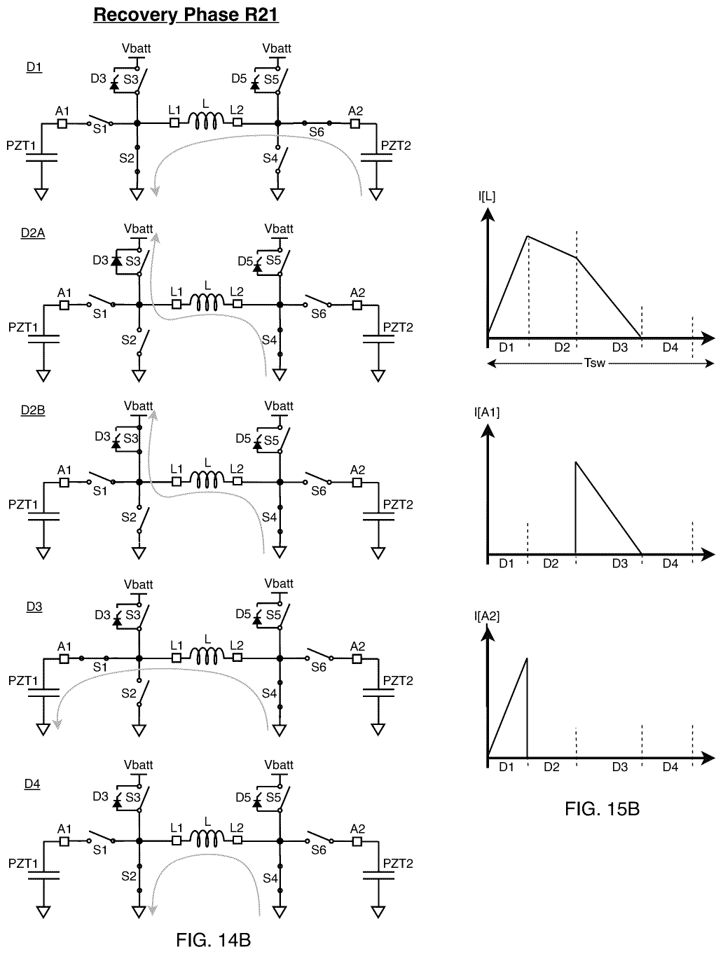

Recovery phase R12 is now described with reference to FIGS. 14A and 15A. Recovery phase R12 is separated into three sub-phases D1, D2, and D3, followed by sub-phase D4. In phase R12 sub-phase D1, switches S1 and S4 are closed, while the other switches are kept open, having the effect of transferring energy from the piezoelectric actuator PZT1 to the inductor L for storage. This D1 sub-phase can be observed in FIG. 15A, where the current I[L] through the inductor L rises with a slope of VA1/L, and the current I[A1] flowing out of PZT1 rises with a slope of VA1/L.

Next, in phase R12 sub-phase D2, switches S2 and S5 are closed, while the other switches are kept open, having the effect of transferring energy in the inductor L to the battery D3, with the inductor current I[L] falling with a slope of −Vbatt/L as a result as shown in FIG. 15A. To mitigate the effect of a timing mismatch between the opening of switch S4 and the closing of switch S5, the body diode D5 is made active through its related switch to provide for the continuous flow of inductor current I[L]. Specifically, at the instant when switch S4 opens, there is a brief period where there is no direct path for the inductor current I[L] to flow. Nevertheless, the inductor L continues to maintain the direction of inductor current I[L] flow, momentarily elevating the voltage at node L2. If switch S5 is not yet fully closed, this results in the voltage at L2 being higher than Vbatt, forward biasing the body diode D5. This condition allows current conduction through the body diode D5 to Vbatt, thereby providing a temporary path for the inductor current I[L] until switch S5 fully closes, as shown as phase R12 sub-phase “D2A” in FIG. 14A, giving time for switch S5 to close. Once switch S5 fully closes, the path through switch S5 becomes available, and since this path is much lower resistance than the path through the body diode D5, current flow is then through switch S5, which is illustrated as phase R12 sub-phase “D2B” in FIG. 14A.

Next, in phase R12 sub-phase D3, switches S2 and S6 are closed, while the other switches are kept open, having the effect of transferring remaining energy left in the inductor L to the piezoelectric actuator PZT2. Since the inductor current I[L] is flowing from the inductor L to PZT2 at this point, the inductor current I[L] falls with a slope of −VA2/L and the current I[A2] flowing into PZT2 falls with a slope of −VA2/L during sub-phase D3, as shown in FIG. 15A.

In phase R12, sub-phase D4, switches S2 and S4 are closed while the other switches are kept open, with the result being that the current is kept fixed, ideally at zero, ready for the next period in which the current may be reversed or not.

Recovery phase R21 is effectively the inverse of recovery phase R12, and is now described with reference to FIGS. 14B and 15B.

Recovery phase R21 is separated into three sub-phases D1, D2, and D3, followed by sub-phase D4. In phase R21 sub-phase D1, switches S2 and S6 are closed, while the other switches are kept open, having the effect of transferring energy from the piezoelectric actuator PZT2 to the inductor L for storage. This D1 sub-phase can be observed in FIG. 15B, where the current I[L] through the inductor L rises with a slope of VA2/L, and the current I[A2] flowing out of PZT2 rises with a slope of VA2/L.

In phase R21 sub-phase D2, switches S3 and S4 are closed, while the other switches are kept open, having the effect of transferring energy in the inductor L to the battery D3, with the inductor current I[L] falling with a slope of −Vbatt/L as a result as shown in FIG. 15B.

To mitigate the effect of a timing mismatch between the opening of switch S2 and the closing of switch S3, the body diode D3 is made active through its related switch to provide for the continuous flow of inductor current I[L]. Specifically, at the instant when switch S2 is opened, there is a brief period where there is no direct path for the inductor current I[L] to flow. Nevertheless, the inductor L continues to maintain the direction of inductor current I[L] to flow, momentarily elevating the voltage at node L1. If switch S3 is not yet fully closed, this results in the voltage at L1 being higher than Vbatt, forward biasing the body diode D3. This condition allows current conduction through the diode D3 to Vbatt, thereby providing a temporary path for the inductor current I[L] until switch S3 fully closes, as shown as phase R21 sub-phase “D2A” in FIG. 14B, giving time for switch S3 to fully close. Once switch S3 fully closes, the path through switch S3 becomes available, and since this path is much lower resistance than the path through the body diode D3, current flow is then through switch S3, which is illustrated as phase R21 sub-phase “D2B” in FIG. 14B.

In phase R21 sub-phase D3, switches S1 and S4 are closed, while the other switches are kept open, having the effect of transferring remaining energy left in the inductor L to the piezoelectric actuator PZT1. Since the inductor current I[L] is flowing from the inductor L to PZT1 at this point, the inductor current I[L] falls with a slope of −VA1/L and the current I[A1] flowing into PZT1 falls with a slope of −VA1/L during sub-phase D3, as shown in FIG. 15B.

When phase R21 sub-phase D4 is performed, switches S2 and S4 are closed while the other switches are kept open, with the result being that the current is kept fixed, ideally at zero, ready for the next period in which the current may be reversed or not.

Notice than when using the recovery phases R12 and R21 of FIGS. 14A-14B, each working phase (R12, R21, C12, and C21) can be divided into four sub-phases which follow the same general pattern:
D1, charging of the inductor through the discharging actuator;
D2, involving transfer of energy from or to the battery;
D3, discharging the inductor toward the charging actuator; and
D4, freewheeling.

Operation of the control circuitry 21 to select which charging phase and which recovery phase to operate the driver 10″ in, based upon current inputs, is now described. The voltage V[VA1−VA2] is the differential output voltage, and the difference between the differential output voltage V[VA1−VA2] and the differential reference voltage vdm_REF_DATA can be referred to as the “error”. The current sign of the differential reference voltage vdm_REF_DATA can be referred to as the “reference sign”, and the current sign of the slope of the differential reference voltage vdm_REF_DATA can be referred to as the “reference slope sign”.

A single switching period is represented in the graphs of FIGS. 15A-15B. At the end of each switching period, the control circuitry 21 determines which phase (either a charging phase or a recovery phase, and in which direction charge transfer occurs, whether it be from PZT1 to PZT2 or from PZT2 to PZT1) in which to control the driver 10″ during the next switching period, based upon the current phase, the error, the reference sign, and the reference slope sign. The relationships between the current phase, error, reference sign, reference slope sign, and the next phase are now described with additional reference to the table of FIG. 7.

If the current phase is the recovery phase R21 and both the error and the reference sign are negative, then the next phase that the control circuitry 21 controls the driver 10″ to be in is the charging phase C21.

If the current phase is the recovery phase R21 and both the error and the reference slope sign are both positive, then the next phase that the control circuitry 21 controls the driver 10″ to be in is the charging phase C12.

If the current phase is the charging phase C21 and both the error and reference slope sign are positive, then the next phase that the control circuitry 21 controls the driver 10″ to be in is the recovery phase R12.

If the current phase is the recovery phase R12 and both the error and reference slope sign are negative, then the next phase that the control circuitry 21 controls the driver 10″ to be in is the charging phase C21.

If the current phase is the recovery phase R12 and both the error and reference sign are positive, then the next phase that the control circuitry 21 controls the driver 10″ to be in is the recovery phase R12.

If the current phase is the charging phase C12 and both the error and reference slope sign are negative, then the next phase that the control circuitry 21 controls the driver 10″ to be in is the recovery phase R21.

The above relationships between the current state, error, reference sign, reference slope sign set the next state as shown in table form in FIG. 7. If none of the conditions in the table of FIG. 7 can be verified, then the next state will be the current state (e.g., the state will not change).

The state change condition from recovery (either R12 or R21) to charge (C21 or C12) can be related to the residual energy after the D2 sub-phase. Specifically, the time duration of sub-phase D3 in the recovery phase is related to the extra energy stored in the inductor L, which in this sub-phase is transferred back to the battery. When the time duration of sub-phase D3 in the recovery phase approaches zero, it means that extra energy is not stored in the inductor L and therefore the next phase is to be a charging phase. Therefore, a state change condition can be added to the one described before, with this being related to state change from recovery to charge (R21 to C12 or R12 to C21) and the condition is the time duration of sub-phase D3 which approaches zero.

The pulse-widths of sub-phases D1 and D2 are determined by the control circuitry 21 based upon the value of the signals it receives as feedback, namely the differential voltage V[VA1−VA2] and common mode voltage V[(VA1+VA2)/2] as well as the continuous time value of the inductor current I[L] to be averaged over one period (i.e., I_AVG[L]). In general though, for whatever phase is to be performed, each feedback signal may be utilized. From a mathematical point of view, the control circuitry 21 effectively use the voltages VA1 and VA2, but derives them from the measured differential and common mode voltages. This because it is more advantageous to implement a single double-ended differential readout circuit rather than two single-ended readout circuits.

The pulse-width D3 is instead defined by looking at the instantaneous value of the inductor current I[L] and, more precisely, by looking for the zero crossing.

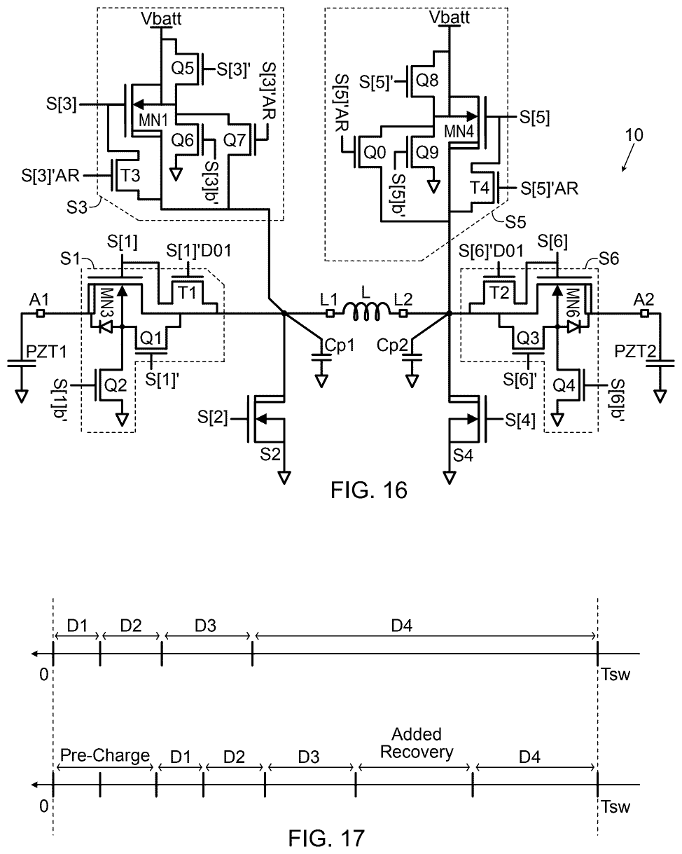

The above-described drivers and control phases solve a variety of issues in the art and are highly efficiency in many applications. However, certain applications call for even greater reduction of power consumption. Refer now to the driver 10 of FIG. 16, which can be driven according to the above-described charging and recovery phases utilizing the above described control circuitry 21, and in which the switches S1-S6 are extended drain MOSFETs with their intrinsic body diodes illustrated.

Observe that the arrangement for the switches S1 and S6 is as it is shown (and described with reference to) FIG. 8, where the body of the transistor forming switch S1 is connected to ground through transistor Q2 when the transistor forming switch S1 is turned off, where the body of the transistor forming switch S1 is connected to its source through transistor Q1 when the transistor forming switch S1 is turned on or when the intrinsic body-drain diode of the switch forming S1 is to be exploited, where the gate of the transistor forming switch S1 is connected to its source through transistor T1 when it is desired to configure the transistor forming switch S1 as a trans-diode, where the body of the transistor forming switch S6 is connected to ground through transistor Q4 when the transistor forming switch S6 is turned off, where the body of the transistor forming switch S6 is connected to its source through transistor Q3 when the transistor forming switch S6 is turned on or when the intrinsic body-drain diode of the switch forming S6 is to be exploited, and where the gate of the transistor forming switch S6 is connected to its source through transistor T2 when it is desired to configure the transistor forming switch S6 as a trans-diode.

Notice, however, that the arrangement for switches S3 and S5 in FIG. 16 is different than in FIG. 8. For switch S3 here, it is formed by n-channel transistor MN1 having its source connected to the battery Vbatt, its drain connected to node L1, and its gate coupled to receive gate drive signal S [3], with transistor Q5 connecting the body of MN1 to the battery Vbatty when switch S3 is to be turned on, transistor Q6 connecting the body of MN1 to ground when switch S3 is to be turned off, transistor Q7 connecting the body of MN1 to the drain of MN1 (and therefore node L1) when it is desired to exploit the intrinsic body-source diode within MN1, and transistor T3 selectively connecting the gate of MN1 and drain of MN1 to utilize MN1 as a trans-diode. Similarly, for switch S5 here, it is formed by n-channel transistor MN4 having its source connected to the battery Vbatt, its drain connected to node L2, and its gate coupled to receive gate drive signal S [5], with transistor Q8 connecting the body of MN4 to the battery Vbatty when switch S5 is to be turned on, transistor Q9 connecting the body of MN4 to ground when switch S5 is to be turned off, transistor Q0 connecting the body of MN4 to the drain of MN4 (and therefore node L2) when it is desired to exploit the intrinsic body-source diode within MN4, and transistor T4 selectively connecting the gate and drain of MN4 when it is desired to utilize MN4 as a trans-diode.

In order to reduce power consumption as much as possible, energy dissipation is to be reduced as much as possible. Sources of energy dissipation include not only the transistors forming the switches S1-S6 (as current flowing therethrough is dissipated as heat), but also the parasitic capacitances Cp1 and Cp2 seen at nodes L1 and L2.

Refer now additionally to FIG. 3A showing charging phase C12. The charging sub-phases proceed from D1 to D4, and then repeat, starting again with D4, which is a freewheeling sub-phase. Therefore, at the start of sub-phase D1, nodes L1 and L2 are at ground and the parasitic capacitances Cp1 and Cp2 are in a fully discharged state. In sub-phase D1, the transistors forming switches S1 and S4 are turned on while the other transistors are turned off. At the instant the transistor forming switch S1 is turned on, it could experience a large drain to source voltage due to the fully charged actuator PZT1 and node L1 being at ground; since switch S1 will be operating in saturation where its resistance (also including the Miller effect) is high, the drain-to-source voltage across switch S1 starts high, leading to a momentary high power dissipation by the transistor forming switch S1 in sub-phase D1 of charging phase C12 due to the Joule effect. The converse of this situation is true in sub-phase D1 of charging phase C21 shown in FIG. 3B for reciprocal reasons-momentary high power dissipation by the transistor forming switch S6.

The result of sub-phase D1 is that the energy stored as charge on actuator PZT1 is transferred to the inductor L and stored on its magnetic field. In sub-phase D2, the transistors forming switches S2 and S4 are turned on while the other transistors are turned off, so that further energy is transferred from the battery Vbatt to inductor L. In sub-phase D3, the transistors forming switches S2 and S6 are turned on while the other transistors are turned off, so that the energy stored in the magnetic field of the inductor L is transferred to the actuator PZT2 and stored as charge. This action also serves to charge the parasitic capacitance Cp2. When sub-phase D3 is completed, the freewheeling sub-phase D4 is performed in which the transistors forming switches S2 and S4 are turned on. This has the effect of discharging parasitic capacitance Cp2, thereby losing some of the energy transferred to the parasitic capacitance Cp2 from actuator PZT1. Note that while some of the energy from actuator PZT1 is transferred to parasitic capacitance Cp1 during sub-phase D1, that energy is then transferred to parasitic capacitance Cp2 and actuator PZT2 during sub-phase D3, so the concern in charging phase C12 is the loss of the energy stored in parasitic capacitance Cp2 at the end of sub-phase D3. The converse of this situation is true at the end of sub-phase D3 of charging phase C21 shown in FIG. 3B for reciprocal reasons—the loss of the energy stored in parasitic capacitance Cp1.

Therefore, for applications in which as much reduction of power consumption as possible is desired, further control schemes may be used. Refer first to FIG. 17, diagrammatically representing the addition of a pre-charge sub-phase performed immediately between sub-phases D4 and D1, and the addition of an added recovery sub-phase performed immediately between sub-phases D3 and D4, without an increase in the total time to perform charging phases C12 and C21. Note that since sub-phases D1, D2, and D3 cover a limited portion of the overall switching period Tsw, the additional pre-charge and recovery sub-phases can be inserted without impacting the switching period limit. The addition of the pre-charge sub-phase serves to mitigate the high power consumption due to the Joule effect at switch S1 or S6 at the beginning of sub-phase D1 as described above, and the addition of the added recovery sub-phase performed after sub-phase D3 and before sub-phase D4 serves to recover the energy stored in the parasitic capacitances Cp2 (in charging phase C12) and Cp1 (in charging phase C21).

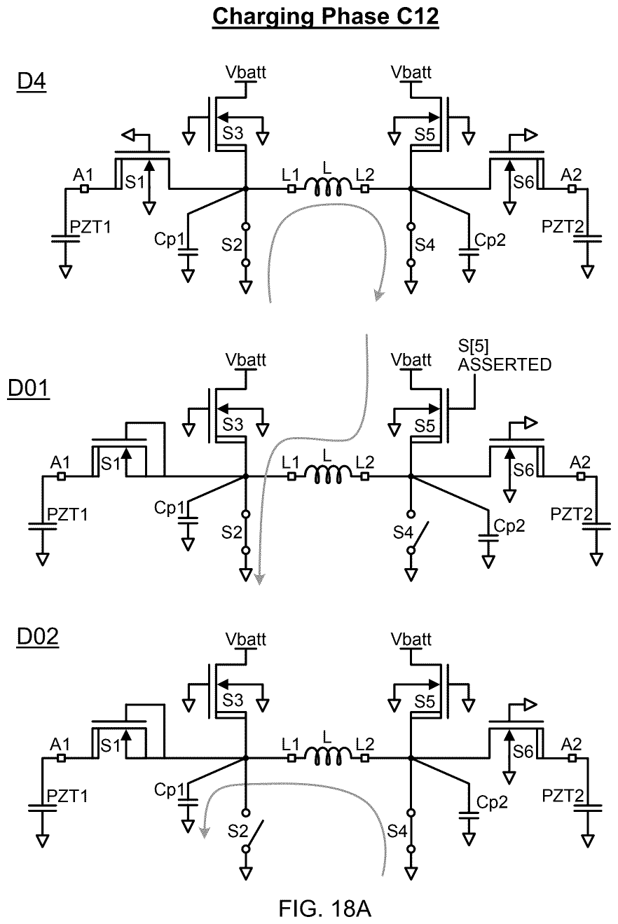

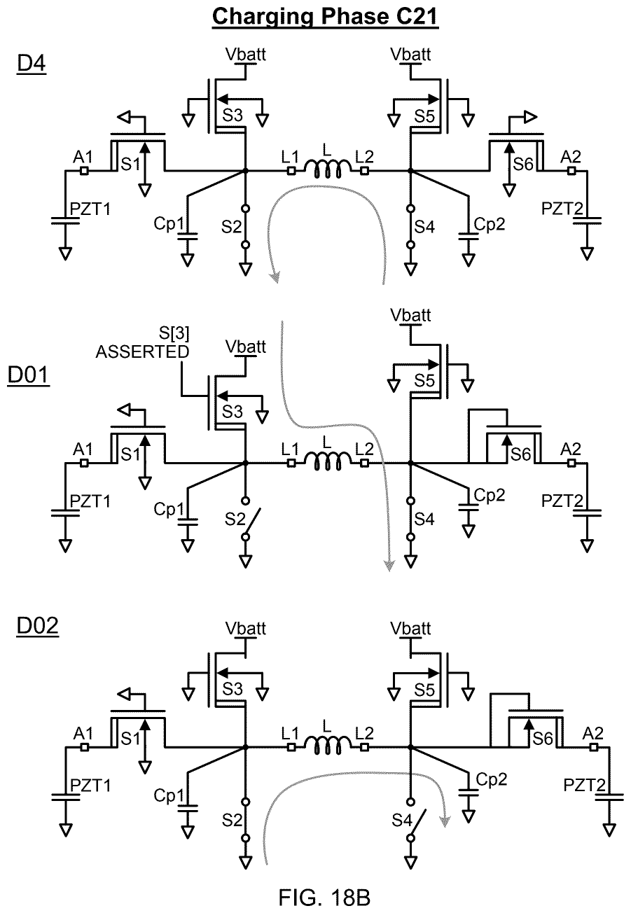

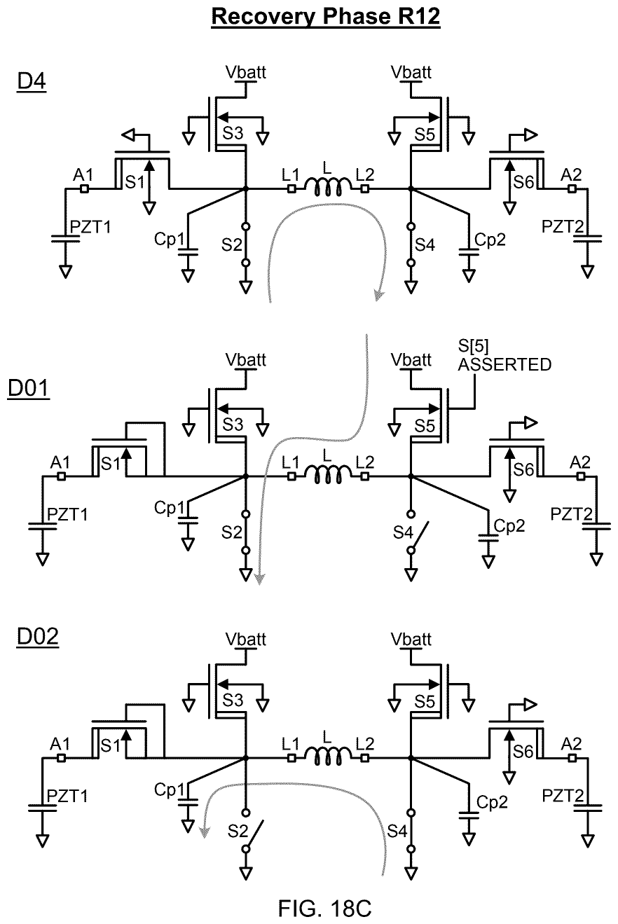

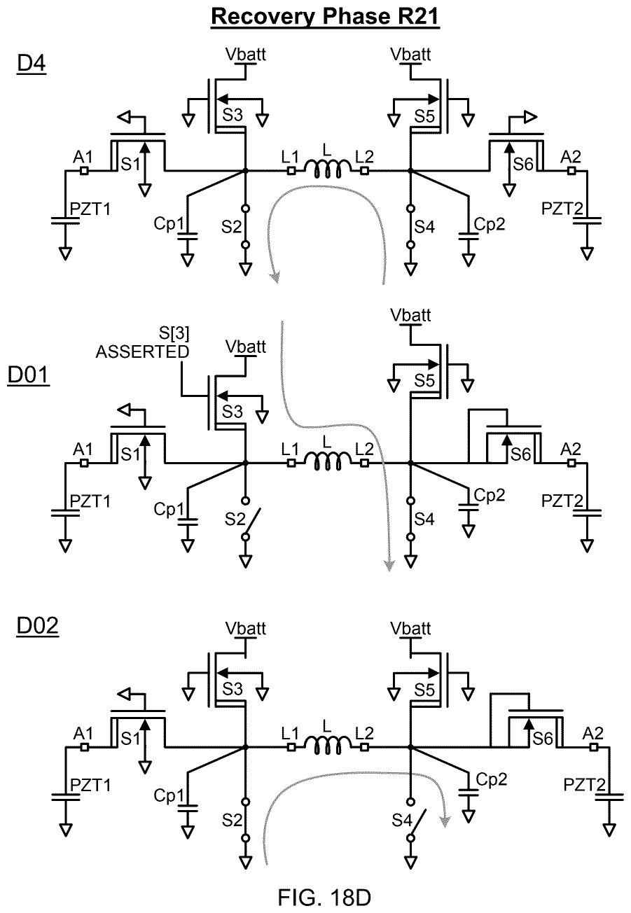

The pre-charge sub-phase for charging phase C12 will now be described with reference to FIG. 18A. The pre-charge sub-phase includes a first part D01 and a second part D02. In the first part D01 of the pre-charge sub-phase, which is performed after each occurrence of charging sub-phase D4 and prior to the next occurrence of charging sub-phase D1, the transistors forming switches S2 and S5 are turned on, and the gate of the transistor forming switch S1 is connected to the source of the transistor forming switch S1 (through transistor T1 as shown in FIG. 16) and transistor Q1 is turned on while transistor Q2 is turned off, so that the transistor forming switch S1 becomes diode coupled, while the other transistors are switched off, with the bodies of switches S3, S5, and S6 being connected to ground (through transistors Q6, Q9, and Q4 as shown in FIG. 16). As a result of this, during DO1, current flows from the battery Vbatt through switch S5 and node L2 to ground through node L1 and switch S2, transferring energy to the inductor L.

Immediately after the first part D01 of the pre-charge sub-phase, the second part D02 is performed. In DO2, all transistors with the exception of the transistor forming switch S1 are turned off, with the bodies of switches S3, S5, and S6 being connected to ground (through transistors Q6, Q9, and Q4 as shown in FIG. 16), and with the transistor forming switch S1 remaining in a diode coupled state. As a result of this, energy from the inductor L is transferred to node L1. This charges not only the parasitic capacitance Cp1 toward the voltage at node A1, but the source, gate capacitance, and body of the transistor forming switch S1 to near the drain voltage of that transistor, providing for approximately zero voltage switching at the instant charging sub-phase D1 begins. Setting the transistor forming switch S1 to be diode coupled also has the effect of preventing the gate-source and source-body voltages of the transistor forming switch S1 from exceeding the absolute maximum ratings (AMR) of the transistor, as might happen if the transistor forming switch S1 were not diode coupled during DO1.

The duration of DO1 may be defined through a monostable, with this duration being defined such that the energy dissipated by the transistor forming switch S1 is equalized with the energy transferred from the battery Vbatt; if the duration were to be too short, node L1 would be insufficiently charged to reduce the power dissipation through the transistor forming switch S1 at the instant charging sub-phase D1 begins, and if the duration were to be too long, the energy transferred from the battery Vbatt to node L1 would be greater than the savings from the reduction of the power dissipation through the transistor forming switch S1 at the instant charging sub-phase D1 begins. Thus, appreciate that the duration of D01 is defined asynchronously, meaning that by design it is only possible to estimate an optimal duration (against PVT variation) following the aforementioned criteria to balance the power dissipation of this additional sub-phase with the recovery of the S1 power dissipation due to the large drain-to-source voltage at the beginning of the transient.

The duration of D02 may be set considering the worst-case scenario for the transistor forming switch S1 in terms of temperature, voltage, and MOS corners. Alternatively, D02 may end when a zero cross of the current is detected (for example, using a zero cross detector such as that labeled 22 in FIG. 8). Here, appreciate that the duration DO2 can be similarly defined by design, but that it is beneficial to exploit the zero cross detector already present to complete this sub-phase as soon as the current in the inductor has been fully discharged. Note that if D02 is shorter than the optimal value, less than all charge accumulated in the inductor will be transferred to charge the node L1.

Refer now to FIG. 18B for the equivalent pre-charge sub-phase of charging phase C21. In the first part D01 of the pre-charge sub-phase, which is performed after each occurrence of charging sub-phase D4, the transistors forming switches S4 and S3 are turned on, and the gate of the transistor forming switch S6 is connected to the source of the transistor forming switch S6 (through transistor T2 as shown in FIG. 16) and transistor Q3 is turned on while transistor Q4 is turned off, so that the transistor becomes diode coupled, with the bodies of switches S3, S5, S1 being connected to ground (through transistors Q6, Q9, and Q2 as shown in FIG. 16). As a result of this, during DO1, current flows from the battery Vbatt through switch S3 and node L1 to ground through node L2 and switch S4, transferring energy to the inductor L.

After the first part D01 of the pre-charge sub-phase of charging phase C21, the second part D02 is performed. In DO2, all transistors with the exception of the transistor forming switch S6 are turned off, with the bodies of switches S3, S5, S1 being connected to ground (through transistors Q6, Q9, and Q2 as shown in FIG. 16), with the transistor forming switch S6 remaining in a diode coupled state. As a result of this, energy from the inductor L is transferred to node L2 to charge not only the parasitic capacitance Cp2 toward the voltage at node A2, but also to charge the source, gate capacitance, and body of the transistor forming switch S6 to near the drain voltage of that transistor, providing for approximately zero voltage switching at the instant charging sub-phase D1 begins.

The duration of DO1 is defined through a monostable, with this duration being defined such that the energy dissipated by the transistor forming switch S1 is equalized with the energy transferred from the battery Vbatt, as described above.

The duration of D02 may be set considering the worst-case scenario for the transistor forming switch S1 in terms of temperature, voltage, and MOS corners, or may end when a zero cross of the current is detected, as described above.

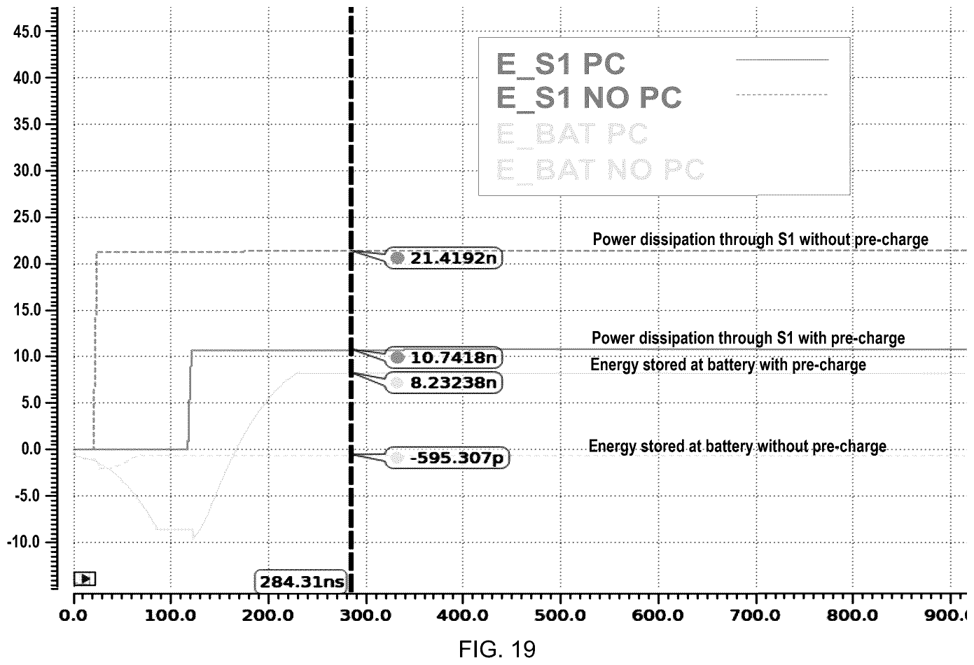

Refer now to the graph of FIG. 19 showing the power dissipation by the transistor forming switch S1 in a recovery phase, with and without the pre-charge sub-phase. As can be seen, with the use of the pre-charge sub-phase, power dissipation (energy lost) is reduced by approximately 50%. As can also be seen, while more energy is withdrawn from the battery Vbatt initially using the pre-charge sub-phase than without using the pre-charge sub-phase, that energy is ultimately returned to the battery Vbatt with the pre-charge sub-phase.

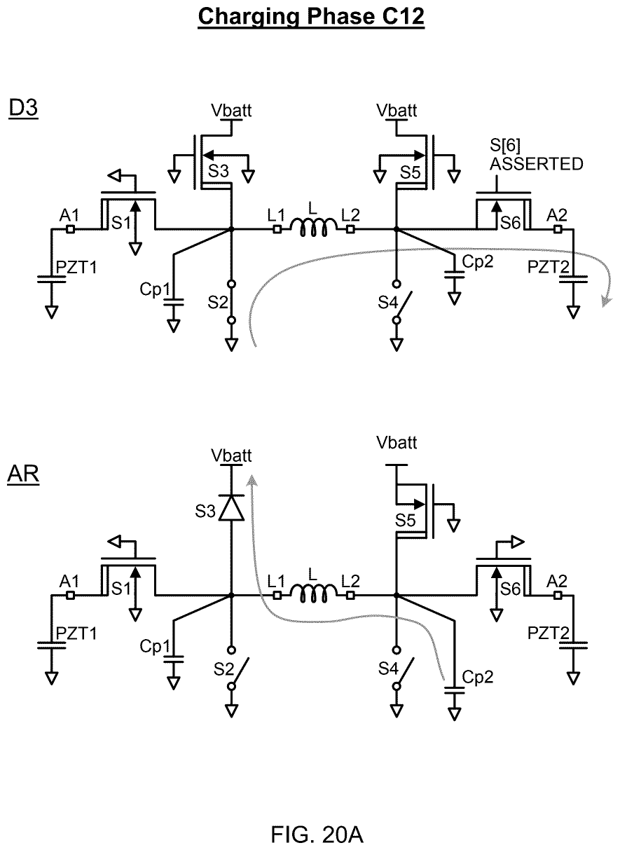

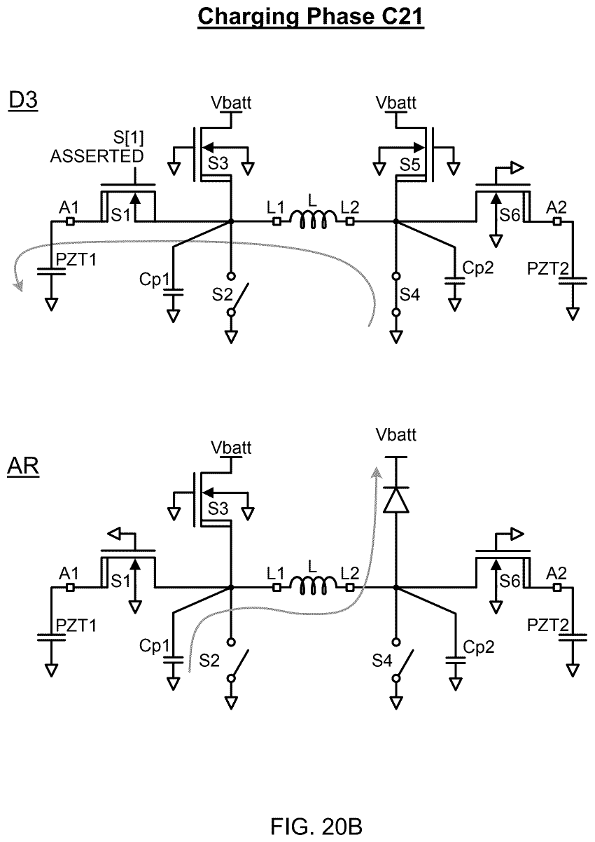

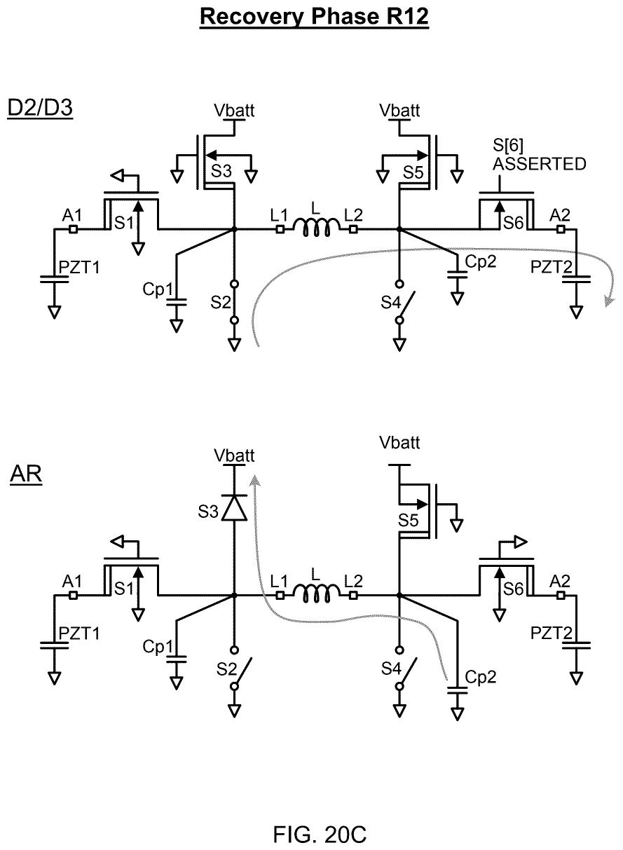

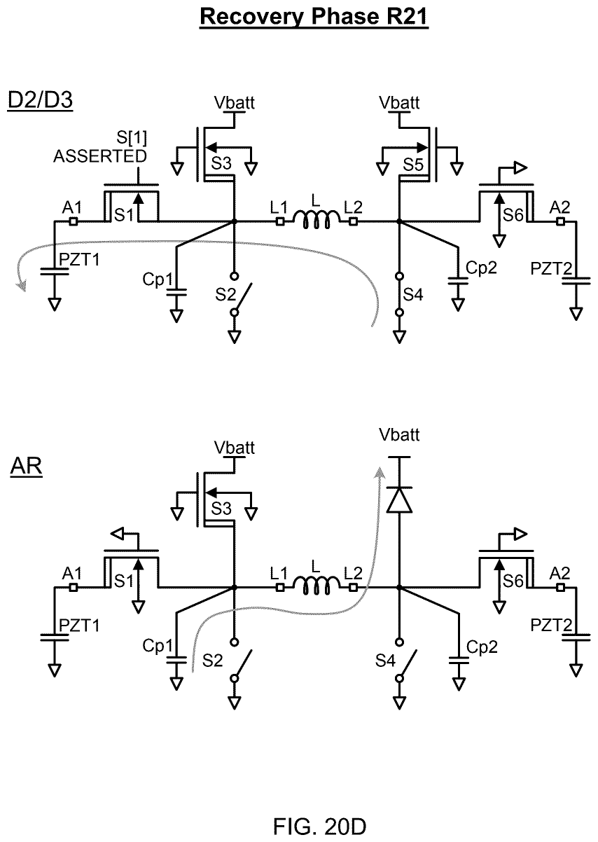

The added recovery sub-phase for charging phase C12 will now be described with reference to FIG. 20A. Here, the added recovery sub-phase includes a single part AR, which is performed after each occurrence of the charging sub-phase D3. In the added recovery sub-phase AR, all transistors forming the switches are turned off with the exception of the transistor forming switch S3, which is configured as a diode with its anode connected to node L1 and its cathode connected to Vbatt, performed by activation of transistor Q7 to connect the body and drain of the transistor MN1 forming switch S3 in order to exploit the intrinsic body-source diode of MN3, or is directly configured as a trans-diode, performed by activation of transistor T3 to connect the gate and drain of the transistor forming switch S3. The bodies of switches S1, S5, and S6 are connected to ground (through transistors Q2, Q9, and Q4 as shown in FIG. 16). Energy transfers from the parasitic capacitance Cp2 to the inductor L until the voltage at node L2 becomes greater than the sum of the battery voltage Vbatt and the voltage across the diode coupled transistor forming switch S3. At this point, the body diode of the transistor forming switch S3 becomes forward biased, and the inductor is discharged toward the battery Vbatt.

The duration of AR may be set considering the worst-case scenario for the transistor forming switch S3 in terms of temperature, voltage, and MOS corners, or may end when a zero cross of the current is detected, as described above. If the duration of AR would be too short, the energy recovery from the parasitic capacitance Cp2 would be less than ideal, although an excessive AR duration would not have deleterious effects.

Refer now to FIG. 20B for the equivalent added recovery sub-phase of charging phase C21. All transistors forming the switches are turned off with the exception of the transistor MN4 forming switch S5, is configured as a diode with its anode connected to node L2 and its cathode connected to Vbatt, performed by activation of transistor Q0 to connect the body and drain of the transistor forming switch S5 in order to exploit the intrinsic body-source diode of MN4, or is directly configured as a trans-diode, performed by activation of transistor T4 to connect the gate and drain of the transistor forming switch S5. The bodies of switches S1, S3, and S6 are connected to ground (through transistors Q2, Q6, and Q4 as shown in FIG. 16). Energy transfers from the parasitic capacitance Cp1 to the inductor L until the voltage at node L1 becomes greater than the sum of the battery voltage Vbatt and the voltage across the diode coupled transistor forming switch S5, at which point the body diode of the transistor forming switch S5 becomes forward biased, and the inductor is discharged toward the batter Vbatt.

As explained, the duration of AR may be set considering the worst-case scenario for the transistor forming switch S3 in terms of temperature, voltage, and MOS corners, or may end when a zero cross of the current is detected, as described above.

It is to be appreciated that the pre-charge and additional recovery sub-phases may be utilized alone or together. For example, the charging sub-phase order may be: D01, D02, D1, D2, D3, D4; D01, DO2, D1, D2, D3, AR, D4; or D1, D2, D3, AR, D4; or D1, D2, D3, AR, D4, D01, D02.

Note that since the voltages involved in the pre-charge sub-phase and the additional recovery sub-phase are low, so added dissipation through the utilized switches is low.

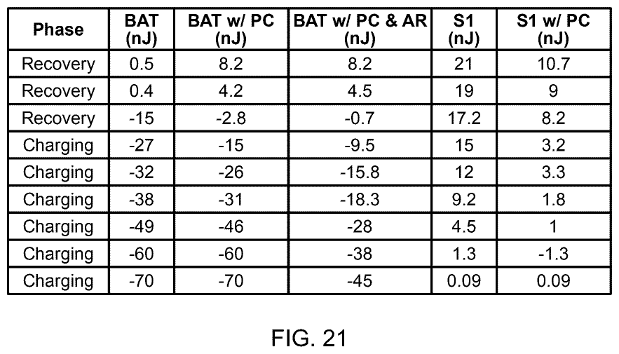

Results of the pre-charge and additional recovery sub-phases may be seen in the table of FIG. 21. Observe that energy consumption in both charging and recovery phases is decreased with both the pre-charge sub-phase alone (without performance of the additional recovery sub-phase) and the pre-charge sub-phase and additional recovery sub-phase both being performed, but that charge recovery by the battery is increased the most through utilizing both the pre-charge sub-phase and the additional recovery sub-phase.

Hereinabove, the pre-charge sub-phase DO1, D02 has been described as being performed between each charging sub-phase D4 and each charging sub-phase D1. However, this need not be the case. Note that each charging or recovery phase has similar D1 and D4 sub-phases (e.g., charging phase C12 and recovery phase R12 have similar topologies in sub-phases D1 and D4, and charging phase C21 and recovery phase R21 have similar topologies in sub-phases D1 and D4). Therefore, it should be appreciated that corresponding pre-charge sub-phases DO1, DO2 can be inserted prior to sub-phase D1 of any charging phase or of recovery phase, regardless of the previous phase (which has completed with its own sub-phase D4), when desired. In greater detail, due to the similar topologies of sub-phases D1 and D4 of each charging and each recovery phase, a corresponding pre-charge sub-phase D01, D02 (shown in FIGS. 18A, 18C) may be performed prior to sub-phase D1 of any charging phase C12 or recovery phase R12 regardless of the previous phase (which has completed its own sub-phase D4), and a corresponding pre-charge sub-phase DO1, D02 (shown in FIGS. 18B, 18D) may be performed before a sub-phase D1 of any charging phase C21 or recovery phase R21 regardless of the previous phase (which has completed with its own sub-phase D4).

Similarly to the above, the additional recovery sub-phase AR has been described as being performed after a sub-phase D3 of a charging phase C12 or C21. Here it should be appreciated that since the additional recovery sub-phase AR is performed entirely within a single charging phase C12 (shown in FIG. 20A) or C21 (shown in FIG. 20B), the previous phase is of no concern and the subsequent phase is of no concern. Therefore, a corresponding additional recovery sub-phase AR may be performed after any sub-phase of any charging phase or recovery phase that is topologically similar to sub-phase D3 as shown in FIGS. 20A-20B, as desired. For example, when performing the recovery phases R12 or R21 of FIGS. 14A-14B, the corresponding additional recovery sub-phase may be performed after sub-phase D3, as shown in FIGS. 20C-20D.

Of interest is that the efficiency will be different depending upon whether the pre-charge sub-phase D01, DO2 is used in a charging phase or a recovery phase. When used in a recovery phase, the pre-charge sub-phase DO1, DO2 is more efficient than when used in a charging phase, since the actuator to be discharged is at a high voltage (and therefore the drain-to-source voltage across the transistor forming switch S1 or S6 will be at a higher voltage than when in a charging phase).

The efficiency of the additional recovery sub-phase AR is similarly different depending upon whether used in a charging phase or a recovery phase. When used in a charging phase, the additional recovery sub-phase AR is more efficient since the actuator to be charged can be at a higher voltage than in a recovery phase, so the related parasitic capacitance has a higher charge prior to performance of the additional recovery sub-phase AR.

The benefits provided by the pre-charge and added recovery sub-phases are multiple. For example, there is substantially reduced power dissipation from switching, as described in detail above. Additionally, there is increased power recovery, as the charge on the parasitics is now recovered. Furthermore, the charging of the parasitic capacitance Cp1 or Cp2 seen at the node of the switch S1 or S6 to be switched on during charging sub-phase D1 reduces the charge sharing effect between the actuator PZT1 or PZT2 and the parasitic capacitance, resulting in improved tracking capabilities. Moreover, the switches S1 and S6 at the inductor terminals L1 and L2 can be designed to reduce their on-resistance without strict considerations on the parasitic capacitances Cp1 and Cp2 they introduced, thanks to the pre-charge and added recovery sub-phases, improving both power consumption and closed-loop stability. Finally, these pre-charge and added recovery sub-phases may be applied in any switching circuit for which high-voltage switching and parasitics are challenging in terms of technology and dissipation.

While the disclosure has been described with respect to a limited number of embodiments, those skilled in the art, having benefit of this disclosure, will appreciate that other embodiments can be envisioned that do not depart from the scope of the disclosure as disclosed herein. Accordingly, the scope of the disclosure shall be limited only by the attached claims.

1. A driver system for a differential piezoelectric actuator system, the driver system comprising:
an inductor connected between first and second nodes;
a driver circuit comprising switches for selectively facilitating transfer of energy between first and second actuators of the differential piezoelectric actuator system and the inductor, and between a voltage supply node and the inductor; and
control circuitry configured to:
determine whether a next phase in which to operate the driver circuit is a first charging phase or a first recovery phase, based upon feedback signals;
in the first charging phase:
in a first sub-phase of the first charging phase, operate the switches to transfer energy from the first actuator to the inductor;
in a second sub-phase of the first charging phase, operate the switches to transfer energy from the voltage supply node to the inductor;
in a third sub-phase of the first charging phase, operate the switches to transfer energy from the inductor to the second actuator; and
in a fourth sub-phase of the first charging phase, operate the switches to cause the inductor to freewheel;
in the first recovery phase:
in a first sub-phase of the first recovery phase, operate the switches to transfer energy from the first actuator to the inductor;
in a second sub-phase of the first recovery phase, operate the switches to transfer energy from the inductor to the voltage supply node; and
in a third sub-phase of the first recovery phase, operate the switches to transfer energy from the inductor to the second actuator;
in a fourth sub-phase of the first recovery phase, operate the switches to cause the inductor to freewheel; and
immediately after the third sub-phase of the first charging phase and/or immediately after the third sub-phase of the first recovery phase, operate the switches to perform an additional recovery sub-phase to transfer energy stored in a parasitic capacitance associated with the second node to the voltage supply node.

2. The driver system of claim 1, wherein the control circuitry is configured to, during the additional recovery sub-phase, set a given one of the switches connected between the first node and the voltage supply node to conduct through a body diode of a transistor forming that given one of the switches.

3. The driver system of claim 1, wherein the switches in the driver circuit comprise:
a first switch circuit connected between the first actuator and the first node;
a second switch circuit connected between the first node and ground;
a third switch circuit connected between the voltage supply node and the first node;
a fourth switch circuit connected between the second node and ground;
a fifth switch circuit connected between the voltage supply node and the second node; and
a sixth switch circuit connected between the second node and the second actuator.

4. The driver system of claim 3, wherein the third switch circuit comprises:
a third n-channel transistor having a source connected to the voltage supply node, a drain connected to the first node, and a gate coupled to receive a third gate drive signal from the control circuitry;
a second transistor configured to connect a body of the third n-channel transistor to the drain of the third n-channel transistor during the additional recovery sub-phase;
a third transistor configured to connect the body of the third n-channel transistor to the voltage supply node when the third n-channel transistor is set by the third gate drive signal to be on; and
a fourth transistor configured to connect the body of the third n-channel transistor to ground when the third n-channel transistor is set by the third gate drive signal to be off.

5. The driver system of claim 4, wherein the fifth switch circuit comprises:
a fifth n-channel transistor having a source connected to the voltage supply node, a drain connected to the second node, and a gate coupled to receive a fifth gate drive signal from the control circuitry;
a sixth transistor configured to connect a body of the fifth n-channel transistor to the drain of the fifth n-channel transistor during the additional recovery sub-phase;
a seventh transistor configured to connect the body of the fifth n-channel transistor to the voltage supply node when the fifth n-channel transistor is set by the fifth gate drive signal to be on; and
an eighth transistor configured to connect the body of the fifth n-channel transistor to ground when the fifth n-channel transistor is set by the fifth gate drive signal to be off.

6. The driver system of claim 5, wherein the control circuitry is further configured to, immediately prior to the first sub-phase of the first charging phase and/or immediately prior to the first sub-phase of the first recovery phase, operate the switches to perform a pre-charge sub-phase to place a given one of the switches connected to the first actuator near a zero-voltage switching condition; and
wherein the first switch circuit comprises:
a first n-channel transistor having a drain connected to the first actuator, a source connected to the first node, and a gate coupled to receive a first gate drive signal from the control circuitry;
a ninth transistor configured to selectively connect the gate of the first n-channel transistor to the source of the first n-channel transistor in order to configure the first n-channel transistor as a trans-diode during the pre-charge sub-phase;
a tenth transistor configured to connect a body of the first n-channel transistor to ground when the first n-channel transistor is set by the first gate drive signal to be off; and
an eleventh transistor configured to connect the body of the first n-channel transistor to the source of the first n-channel transistor when the first n-channel transistor is set by the first gate drive signal to be on, during the pre-charge sub-phase, and to exploit a body-drain junction of the first n-channel transistor.

7. The driver system of claim 6, wherein the sixth switch circuit comprises:
a sixth n-channel transistor having a drain connected to the first actuator, a source connected to the first node, and a gate coupled to receive a first gate drive signal from the control circuitry;
a twelfth transistor configured to selectively connect the gate of the sixth n-channel transistor to the source of the sixth n-channel transistor in order to configure the sixth n-channel transistor as a trans-diode during the pre-charge sub-phase;
a thirteenth transistor configured to connect a body of the sixth n-channel transistor to ground when the sixth n-channel transistor is set by the first gate drive signal to be off; and
a fourteenth transistor configured to connect the body of the sixth n-channel transistor to the source of the sixth n-channel transistor when the sixth n-channel transistor is set by the first gate drive signal to be on, during the pre-charge sub-phase, and to exploit the body-drain junction of the sixth n-channel transistor.

8. A driver system for a differential piezoelectric actuator system, the driver system comprising:
an inductor connected between first and second nodes;
a driver circuit comprising switches for selectively facilitating transfer of energy between first and second actuators of the differential piezoelectric actuator system and the inductor, and between a voltage supply node and the inductor; and
control circuitry configured to:
determine whether a next phase in which to operate the driver circuit is a first charging phase or a first recovery phase, based upon feedback signals;
in the first charging phase:
in a first sub-phase of the first charging phase, operate the switches to transfer energy from the first actuator to the inductor;
in a second sub-phase of the first charging phase, operate the switches to transfer energy from the voltage supply node to the inductor;
in a third sub-phase of the first charging phase, operate the switches to transfer energy from the inductor to the second actuator; and
in a fourth sub-phase of the first charging phase, operate the switches to cause the inductor to freewheel;
in the first recovery phase:
in a first sub-phase of the first recovery phase, operate the switches to transfer energy from the first actuator to the inductor;
in a second sub-phase of the first recovery phase, operate the switches to transfer energy from the inductor to the voltage supply node;
in a third sub-phase of the first recovery phase, operate the switches to transfer energy from the inductor to the second actuator;
in a fourth sub-phase of the first recovery phase, operate the switches to cause the inductor to freewheel; and
prior to the first sub-phase of the first charging phase and/or prior to the first sub-phase of the first recovery phase, operate the switches to perform a pre-charge sub-phase to place a given one of the switches connected to the first actuator near a zero-voltage switching condition.

9. The driver system of claim 8, wherein the control circuitry is configured to perform the pre-charge sub-phase by operating the switches to pre-charge a gate capacitance and other intrinsic capacitances of the given one of the switches connected to the first actuator and to pre-charge a parasitic capacitance seen at the first node.

10. The driver system of claim 8, wherein the control circuitry is configured to perform the pre-charge sub-phase by: in a first part of the pre-charge sub-phase, operate the switches to transfer energy from the voltage supply node to the inductor, and in a second part of the pre-charge sub-phase, operate the switches to transfer energy from the inductor to a gate capacitance of the given one of the switches connected to the first actuator and to a parasitic capacitance seen at the first node.

11. The driver system of claim 10, wherein a duration of the first part of the pre-charge sub-phase is set by the control circuitry to be such that energy transferred from the voltage supply node to the inductor during the first part of the pre-charge sub-phase is equal to energy dissipated by the given one of the switches connected to the first actuator during the pre-charge sub-phase.

12. The driver system of claim 10, wherein a duration of the second part of the pre-charge sub-phase is set by the control circuitry to be such that the energy stored in the inductor during the first part of the pre-charge sub-phase is fully transferred to the gate capacitance of the given one of the switches connected to the first actuator and the parasitic capacitance seen at the first node.

13. The driver system of claim 10, wherein a duration of the second part of the pre-charge sub-phase is set by the control circuitry based upon a zero crossing of an instantaneous value of an inductor current through the inductor.

14. The driver system of claim 8, wherein the control circuitry is configured to, during the pre-charge sub-phase, place the given one of the switches connected to the first actuator into a diode coupled configuration.

15. The driver system of claim 8, wherein the control circuitry is further configured to, in an additional recovery sub-phase occurring after the third sub-phase of the first charging phase and/or after the third sub-phase of the first recovery phase, operate the switches to transfer energy stored in a parasitic capacitance associated with the second node to the voltage supply node.

16. The driver system of claim 15, wherein a duration of the additional recovery sub-phase is set by the control circuitry based upon a zero crossing of an instantaneous value of an inductor current through the inductor.

17. The driver system of claim 8, wherein the switches in the driver circuit comprise:
a first switch circuit connected between the first actuator and the first node;
a second switch circuit connected between the first node and ground;
a third switch circuit connected between the voltage supply node and the first node;
a fourth switch circuit connected between the second node and ground;
a fifth switch circuit connected between the voltage supply node and the second node; and
a sixth switch circuit connected between the second node and the second actuator.

18. The driver system of claim 17, wherein the control circuitry is further configured to, immediately after the third sub-phase of the first charging phase and/or immediately after the third sub-phase of the first recovery phase, operate the switches to perform an additional recovery sub-phase to transfer energy stored in a parasitic capacitance associated with the second node to the voltage supply node;
wherein the third switch circuit comprises:
a third n-channel transistor having a source connected to the voltage supply node, a drain connected to the first node, and a gate coupled to receive a third gate drive signal from the control circuitry;
a first transistor configured to selectively connect the gate of the third n-channel transistor to the drain of the third n-channel transistor to configure the third n-channel transistor as a trans-diode to perform the additional recovery sub-phase;
a second transistor configured to selectively connect a body of the third n-channel transistor to the drain of the third n-channel transistor to exploit an intrinsic body-source diode of the third n-channel transistor to perform the additional recovery sub-phase;
a third transistor configured to connect the body of the third n-channel transistor to the voltage supply node when the third n-channel transistor is set by the third gate drive signal to be on; and
a fourth transistor configured to connect the body of the third n-channel transistor to ground when the third n-channel transistor is set by the third gate drive signal to be off.

19. The driver system of claim 18, wherein the fifth switch circuit comprises:
a fifth n-channel transistor having a source connected to the voltage supply node, a drain connected to the second node, and a gate coupled to receive a fifth gate drive signal from the control circuitry;
a fifth transistor configured to selectively connect the gate of the fifth n-channel transistor to the drain of the fifth n-channel transistor to configure the fifth n-channel transistor as a trans-diode to perform the additional recovery sub-phase;
a sixth transistor configured to selectively connect a body of the fifth n-channel transistor to the drain of the fifth n-channel transistor to exploit the intrinsic body-source diode of the fifth n-channel transistor to perform the additional recovery sub-phase;
a seventh transistor configured to connect the body of the fifth n-channel transistor to the voltage supply node when the fifth n-channel transistor is set by the fifth gate drive signal to be on; and
an eighth transistor configured to connect the body of the fifth n-channel transistor to ground when the fifth n-channel transistor is set by the fifth gate drive signal to be off.

20. The driver system of claim 19, wherein the first switch circuit comprises:
a first n-channel transistor having a drain connected to the first actuator, a source connected to the first node, and a gate coupled to receive a first gate drive signal from the control circuitry;
a ninth transistor configured to connect the gate of the first n-channel transistor to the source of the first n-channel transistor during the pre-charge sub-phase;
a tenth transistor configured to connect a body of the first n-channel transistor to ground when the first n-channel transistor is set by the first gate drive signal to be off; and
an eleventh transistor configured to connect the body of the first n-channel transistor to the source of the first n-channel transistor when the first n-channel transistor is set by the first gate drive signal to be on, when the pre-charge sub-phase is to be performed, and to exploit a body-drain junction of the first n-channel transistor.

21. The driver system of claim 20, wherein the sixth switch circuit comprises:
a sixth n-channel transistor having a drain connected to the first actuator, a source connected to the first node, and a gate coupled to receive a first gate drive signal from the control circuitry;
a twelfth transistor configured to connect the gate of the sixth n-channel transistor to the source of the sixth n-channel transistor during the pre-charge sub-phase;
a thirteenth transistor configured to connect a body of the sixth n-channel transistor to ground when the sixth n-channel transistor is set by the first gate drive signal to be off; and
a fourteenth transistor configured to connect the body of the sixth n-channel transistor to the source of the sixth n-channel transistor when the sixth n-channel transistor is set by the first gate drive signal to be on, when the pre-charge sub-phase is to be performed, and to exploit the body-drain junction of the sixth n-channel transistor.

22. The driver system of claim 8, wherein the control circuitry is configured to, immediately after the third sub-phase of the first charging phase and/or immediately after the third sub-phase of the first recovery phase, perform an additional recovery sub-phase to operate the switches to transfer energy stored in a parasitic capacitance associated with the second node to the voltage supply node.

23. The driver system of claim 22, wherein the control circuitry is configured to, during the additional recovery sub-phase, set a given one of the switches connected between the first node and the voltage supply node to conduct through a body diode of a transistor forming that given one of the switches.
